(19) United States
(12) Patent Application Publication
(10) Pub. No.: US 2024/0280109 A1
(43) Pub. Date: Aug. 22, 2024

(54) CENTRIFUGAL AIR-SENDING DEVICE, AIR-CONDITIONING APPARATUS, AND REFRIGERATION CYCLE APPARATUS

(71) Applicant: Mitsubishi Electric Corporation, Tokyo (JP)

(72) Inventors: Takuya TERAMOTO, Tokyo (JP); Hiroyasu HAYASHI, Tokyo (JP); Ryo HORIE, Tokyo (JP); Kazuya MICHIKAMI, Tokyo (JP)

(21) Appl. No.: 18/681,157

(22) PCT Filed: Oct. 8, 2021
(86) PCT No.: PCT/JP2021/037369

§ 371 Date: Feb. 5, 2024

(51) Int. Cl. F04D 17/08; F04D 29/28; F04D 29/30; F04D 29/42; F24F 1/0287; F25D 17/06

(52) U.S. Cl. CPC F04D 17/08; F04D 29/281; F04D 29/30; F04D 29/4206; F24F 1/0287; F25D 17/06

(57) ABSTRACT

A centrifugal air-sending device includes an impeller that includes blades and a scroll casing that includes a bell mouth. Each of the blades is formed such that a vane length of the blade decreases from a portion of the blade close to a main plate toward a portion of the blade close to a side plate. Each of the blades includes a first vane portion that includes an outer circumferential end and that is connected to the side plate, and a second vane portion that includes an inner circumferential end, a turbo vane that forms a backward-curved blade, and a portion close to the main plate in an axial direction of a rotation axis that protrudes further inward than the bell mouth. The blades are formed such that a blade outer diameter is larger than an inner diameter of the bell mouth.

### TECHNICAL FIELD

The present disclosure relates to a centrifugal air-sending device including an impeller, an air-conditioning apparatus including the centrifugal air-sending device, and a refrigeration cycle apparatus including the centrifugal air-sending device.

### BACKGROUND ART

There has been a centrifugal air-sending device that includes a spiral-shaped scroll casing having a bell mouth formed at an air inlet and an impeller provided inside the scroll casing and configured to rotate around an axis (see, for example, Patent Literature 1). The impeller of the centrifugal air-sending device of Patent Literature 1 includes a disk-shaped main plate, an annularly shaped side plate, and blades arranged in a radial fashion. Each of the blades of this impeller is formed such that the blade increases in inside diameter from the main plate toward the side plate, is a forward-curved blade formed at an outlet angle of 100 degrees or larger, and includes an inducer portion of a turbo vane (backward-curved blade) on an inner circumference of the blade.

### CITATION LIST

### Patent Literature

Patent Literature 1: Japanese Unexamined Patent Application Publication No. 2000-240590

### SUMMARY OF INVENTION

### Technical Problem

In a case in which the impeller is a resin molded article, the side plate has been provided in an annular shape on an outer circumferential side surface of the impeller to prevent the side plate from becoming stuck in a mold. In the centrifugal air-sending device having the impeller thus formed, a current of air blown out in a radial direction of the impeller may wrap outward around the side plate and flow again into the impeller along an inner wall surface of the bell mouth. In the centrifugal air-sending device of Patent Literature 1, a portion of each of the blades located further outward than is an inner circumferential end portion of the bell mouth is formed solely by a portion that forms an outer circumferential vane portion. Therefore, when the current of air flows again into the impeller, the current of air blown out from the impeller and flowing along the inner wall surface of the bell mouth collides with the outer circumferential vane portion, at which an outlet angle is large and the inflow velocity of the current of air increases. This causes noise from the centrifugal air-sending device and also causes input deterioration.

The present disclosure is made to solve the aforementioned problems and has as an object to provide a centrifugal air-sending device configured such that when a current of air flowing along an inner wall surface of a bell mouth flows again into an impeller, noise and input deterioration caused by the current of air are reduced, an air-conditioning apparatus including the centrifugal air-sending device, and a refrigeration cycle apparatus including the centrifugal air-sending device.

### Solution to Problem

A centrifugal air-sending device according to an embodiment of the present disclosure includes an impeller that includes a main plate to be driven to rotate, a side plate that is annularly shaped and faces the main plate, and a plurality of blades that are connected to the main plate at one end of each of the plurality of blades, connected to the side plate at the other end of each of the plurality of blades, and arranged in a circumferential direction centered around a rotation axis of the main plate that is virtually drawn and a scroll casing that houses the impeller and includes a circumferential wall formed in a spiral shape and a side wall that includes a bell mouth that defines an air inlet that communicates with a space defined by the main plate and the plurality of blades. Each of the plurality of blades is formed such that a vane length of the blade decreases from a portion of the blade close to the main plate toward a portion of the blade close to the side plate. Each of the plurality of blades includes an inner circumferential end located closer to the rotation axis than is an outer circumferential end in a radial direction that starts from the rotation axis as a radial center, the outer circumferential end located closer to an outer circumference of the blade than is the inner circumferential end in the radial direction, a first vane portion that forms a blade that includes the outer circumferential end and is formed such that an outlet angle is formed at 90 degrees or less and the first vane portion is connected to the side plate, and a second vane portion that includes the inner circumferential end, a turbo vane that forms a backward-curved blade, and a portion close to the main plate in an axial direction of the rotation axis that protrudes further inward than the bell mouth when the second vane portion is viewed in the axial direction of the rotation axis. The plurality of blades are formed such that a blade outer diameter defined by the outer circumferential ends of the plurality of blades is larger than an inner diameter of the bell mouth.

An air-conditioning apparatus according to an embodiment of the present disclosure includes the centrifugal air-sending device thus configured.

A refrigeration cycle apparatus according to an embodiment of the present disclosure includes the centrifugal air-sending device thus configured.

### Advantageous Effects of Invention

According to an embodiment of the present disclosure, each of the plurality of blades includes a first vane portion that forms a blade that includes the outer circumferential end and is formed such that an outlet angle is formed at 90 degrees or less. As the outlet angle is formed at 90 degrees or less, the centrifugal air-sending device raises a static pressure when the operating range is in a high pressure loss state and, by including multiple blades, increases an air volume. As a result, by decreasing the outlet angle when the current of air flowing along the inner wall surface of the bell mouth flows again into the impeller, the centrifugal air-sending device reduces a loss caused by a collision with the current of air, thereby reducing noise caused by the current of air and reducing input deterioration.

### BRIEF DESCRIPTION OF DRAWINGS

FIG. 1 is a perspective view schematically showing a centrifugal air-sending device according to Embodiment 1.

FIG. 2 is an outside drawing schematically showing a configuration of the centrifugal air-sending device according to Embodiment 1 as viewed from an angle parallel with a rotation axis.

FIG. 3 is a cross-sectional view schematically showing a cross-section of the centrifugal air-sending device as taken along line A-A in FIG. 2.

FIG. 4 is a perspective view of an impeller of the centrifugal air-sending device according to Embodiment 1.

FIG. 5 is a perspective view of an opposite side of the impeller shown in FIG. 4.

FIG. 6 is a plan view of the impeller of the centrifugal air-sending device according to Embodiment 1 from one side of a main plate.

FIG. 7 is a plan view of the impeller of the centrifugal air-sending device according to Embodiment 1 from the other side of the main plate.

FIG. 8 is a cross-sectional view of the impeller as taken along line B-B in FIG. 6.

FIG. 9 is a side view of the impeller shown in FIG. 4.

FIG. 10 is a schematic view showing blades in a cross-section of the impeller as taken along line C-C in FIG. 9.

FIG. 11 is a schematic view showing an outlet angle of a blade in the cross-section of the impeller as taken along line C-C in FIG. 9.

FIG. 12 is a schematic view showing blades in a cross-section of the impeller as taken along line D-D in FIG. 9.

FIG. 13 is an enlarged view conceptually showing a first example of a blade of the centrifugal air-sending device according to Embodiment 1.

FIG. 14 is an enlarged view conceptually showing a second example of a blade of the centrifugal air-sending device according to Embodiment 1.

FIG. 15 is an enlarged view conceptually showing a third example of a blade of the centrifugal air-sending device according to Embodiment 1.

FIG. 16 is an enlarged view conceptually showing a fourth example of a blade of the centrifugal air-sending device according to Embodiment 1.

FIG. 17 is an enlarged view conceptually showing a fifth example of a blade of the centrifugal air-sending device according to Embodiment 1.

FIG. 18 is an enlarged view conceptually showing a sixth example of a blade of the centrifugal air-sending device according to Embodiment 1.

FIG. 19 is a schematic view showing a relationship between the impeller and a scroll casing in the cross-section of the centrifugal air-sending device as taken along line A-A in FIG. 2.

FIG. 20 is a schematic view showing a relationship between blades and a bell mouth as viewed from an angle parallel with the rotation axis in the impeller shown in FIG. 19.

FIG. 21 is a schematic view showing a relationship between the impeller and the scroll casing in the cross-section of the centrifugal air-sending device as taken along line A-A in FIG. 2.

FIG. 22 is a schematic view showing a relationship between blades and the bell mouth as viewed from an angle parallel with the rotation axis in the impeller shown in FIG. 21.

FIG. 23 is a schematic view showing a relationship between the impeller and the bell mouth in the cross-section of the centrifugal air-sending device as taken along line A-A in FIG. 2.

FIG. 24 is a cross-sectional view of a centrifugal air-sending device according to a comparative example.

FIG. 25 is a cross-sectional view schematically showing a centrifugal air-sending device according to Embodiment 2.

FIG. 26 is a perspective view of an air-conditioning apparatus according to Embodiment 3.

FIG. 27 is a perspective view of an internal configuration of the air-conditioning apparatus according to Embodiment 3.

FIG. 28 is a diagram showing a configuration of a refrigeration cycle apparatus according to Embodiment 4.

### DESCRIPTION OF EMBODIMENTS

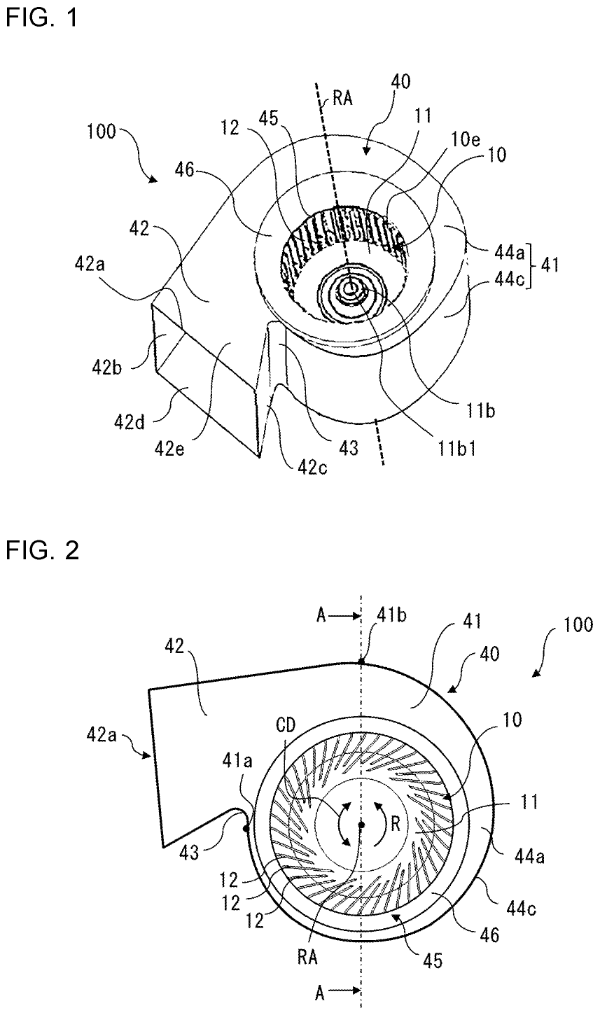

In the following, a centrifugal air-sending device and an air-conditioning apparatus according to embodiments are described, for example, with reference to the drawings. In the following drawings including FIG. 1, relative relationships in dimension between constituent elements, the shapes of the constituent elements, or other features of the constituent elements may be different from actual ones. Further, constituent elements given identical reference signs in the following drawings are identical or equivalent to each other, and these reference signs are adhered to throughout the full text of the description. Further, the directive terms (such as “upper”, “lower”, “right”, “left”, “front”, and “back”) used as appropriate for ease of comprehension are merely so written for convenience of explanation, and are not intended to limit the placement or orientation of a device or a component.

### Embodiment 1

### [Centrifugal Air-sending Device 100]

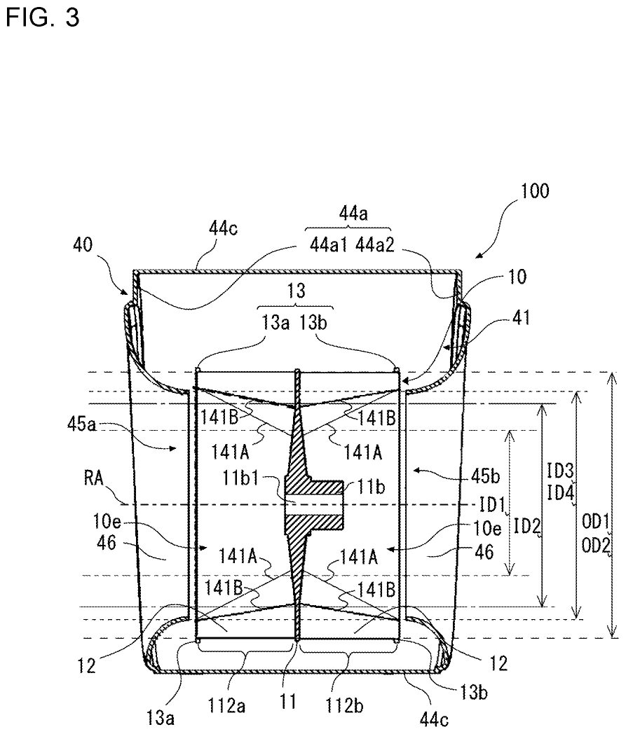

FIG. 1 is a perspective view schematically showing a centrifugal air-sending device 100 according to Embodiment 1. FIG. 2 is an outside drawing schematically showing a configuration of the centrifugal air-sending device 100 according to Embodiment 1 as viewed from an angle parallel with a rotation axis RA. FIG. 3 is a cross-sectional view schematically showing a cross-section of the centrifugal air-sending device 100 as taken along line A-A in FIG. 2. A basic structure of the centrifugal air-sending device 100 is described with reference to FIGS. 1 to 3.

The centrifugal air-sending device 100 is a multi-blade centrifugal air-sending device, and includes an impeller 10 that generates a current of air and a scroll casing 40 that houses the impeller 10 inside. The centrifugal air-sending device 100 is a double-suction centrifugal air-sending device into which air is sucked through both ends of the scroll casing 40 in an axial direction of a rotation axis RA of the impeller 10 that is virtually drawn.

### [Scroll Casing 40]

The scroll casing 40 houses the impeller 10 inside for use in the centrifugal air-sending device 100, and rectifies a flow of air blown out from the impeller 10. The scroll casing 40 includes a scroll portion 41 and a discharge portion 42.

### (Scroll Portion 41)

The scroll portion 41 has an air trunk through which a dynamic pressure of a current of air generated by the impeller 10 is converted into a static pressure. The scroll portion 41 has a side wall 44a covering the impeller 10 in an axial direction of a rotation axis RA of a boss portion 11b of the impeller 10 and having a case air inlet 45 through which air is taken in and a circumferential wall 44c surrounding the impeller 10 in a radial direction of the rotation axis RA of the boss portion 11b.

Further, the scroll portion 41 includes a tongue portion 43 located between the discharge portion 42 and a scroll start portion 41a of the circumferential wall 44c thus forming a curved surface, and allowing a current of air generated by the impeller 10 to be guided toward a discharge port 42a of the discharge portion 42 through the scroll portion 41. It should be noted that the radial direction of the rotation axis RA is a direction perpendicular to the axial direction of the rotation axis RA. The scroll portion 41 has an internal space defined by the circumferential wall 44c and the side wall 44a and the internal space allows air blown out from the impeller 10 to flow along the circumferential wall 44c.

### (Side Wall 44a)

The side wall 44a is disposed on each side of the impeller 10 in the axial direction of the rotation axis RA of the impeller 10. The side wall 44a of the scroll casing 40 has the case air inlet 45 so that air is allowed to flow between the impeller 10 and the outside of the scroll casing 40.

The case air inlet 45 is formed in a circular shape, and is disposed such that the center of the case air inlet 45 and the center of the boss portion 11b of the impeller 10 substantially coincide with each other. It should be noted that the shape of the case air inlet 45 is not limited to the circular shape and may be another shape such as an elliptical shape.

The scroll casing 40 of the centrifugal air-sending device 100 is a double-suction casing having the side walls 44a on both respective sides of a main plate 11 in the axial direction of the rotation axis RA of the boss portion 11b and each side wall 44a is provided with the case air inlet 45.

The centrifugal air-sending device 100 has two side walls 44a in the scroll casing 40. The two side walls 44a are formed to face each other across the circumferential wall 44c. More specifically, as shown in FIG. 3, the scroll casing 40 has a first side wall 44a 1 and a second side wall 44a2 as the side walls 44a.

The first side wall 44a1 forms a first air inlet 45a. The first air inlet 45a faces a plate side of the main plate 11 on which a first side plate 13a, which is described later, is disposed. The second side wall 44a2 forms a second air inlet 45b. The second air inlet 45b faces a plate side of the main plate 11 on which a second side plate 13b, which is described later, is disposed. It should be noted that the aforementioned case air inlet 45 is a generic name for the first air inlet 45a and the second air inlet 45b.

The case air inlet 45 of the side wall 44a is formed by a bell mouth 46. The bell mouth 46 has a case air inlet 45, which communicates with a space defined by the main plate 11 and a plurality of blades 12. The bell mouth 46 allows gas that is sucked into the impeller 10 to be rectified and flow into the impeller 10 through an air inlet 10e of the impeller 10.

The bell mouth 46 has an opening whose diameter gradually decreases from the outside toward the inside of the scroll casing 40. Such a configuration of the side wall 44a allows air in the vicinity of the case air inlet 45 to smoothly flow along the bell mouth 46 and efficiently flow into the impeller 10 through the case air inlet 45.

### (Circumferential Wall 44c)

The circumferential wall 44c is a wall, which allows a current of air generated by the impeller 10 to be guided to the discharge port 42a along a curved wall surface. The circumferential wall 44c is a wall provided between the side walls 44a , which face each other, and forms a curved surface extending along the direction of rotation R of the impeller 10. The circumferential wall 44c is for example disposed parallel with the axial direction of the rotation axis RA of the impeller 10 and covers the impeller 10. It should be noted that the circumferential wall 44c may be formed at a slant inclined to the axial direction of the rotation axis RA of the impeller 10, and is not limited to being formed to be disposed parallel with the axial direction of the rotation axis RA.

The circumferential wall 44c covers the impeller 10 in a radial direction of the boss portion 11b, and forms an inner circumferential surface that faces the plurality of blades 12, which is described later. The circumferential wall 44c faces ends of the blades 12 through which air is blown out from the impeller 10. As shown in FIG. 2, the circumferential wall 44c is provided over an area from the scroll start portion 41a, which is located at a boundary between the circumferential wall 44c and the tongue portion 43, to a scroll end portion 41b, which is located at a point of a boundary between the discharge portion 42 and the scroll portion 41 that is farthest away from the tongue portion 43, along the direction of rotation R of the impeller 10.

The scroll start portion 41a is an end portion of the circumferential wall 44c, which forms a curved surface, situated upstream in a direction of flow of gas allowed by rotation of the impeller 10 to flow along the circumferential wall 44c through an internal space of the scroll casing 40. The scroll end portion 41b is an end portion of the circumferential wall 44c, which forms a curved surface, situated downstream in the direction of flow of gas allowed by the rotation of the impeller 10 to flow along the circumferential wall 44c through the internal space of the scroll casing 40.

The circumferential wall 44c is formed in a spiral shape. An example of the spiral shape is a shape based on a logarithmic spiral, a spiral of Archimedes, or an involute curve. The inner circumferential surface of the circumferential wall 44c forms a curved surface smoothly curved along a circumferential direction of the impeller 10 from the scroll start portion 41a, from which the circumferential wall 44c extends to be formed in the spiral shape, to the scroll end portion 41b, until which the circumferential wall 44c extends to be formed in the spiral shape. Such a configuration allows air sent out from the impeller 10 to smoothly flow through a gap between the impeller 10 and the circumferential wall 44c in a direction toward the discharge portion 42. This effects an efficient rise in static pressure of air from the tongue portion 43 toward the discharge portion 42 in the scroll casing 40.

### (Discharge Portion 42)

The discharge portion 42 has a discharge port 42a, which allows a current of air that is generated by the impeller 10 and passes through the scroll portion 41 to be discharged through the discharge port 42a. The discharge portion 42 is formed by a hollow pipe having a rectangular cross-section orthogonal to a flow direction of air flowing along the circumferential wall 44c. It should be noted that the cross-sectional shape of the discharge portion 42 is not limited to a rectangle. The discharge portion 42 has a flow passage through which air that is sent out from the impeller 10 and flows through a gap between the circumferential wall 44c and the impeller 10 is allowed to be guided and exhausted out of the scroll casing 40.

As shown in FIG. 1, the discharge portion 42 includes an extension plate 42b, a diffuser plate 42c, a first side plate portion 42d, and a second side plate portion 42e. The extension plate 42b smoothly continues into the scroll end portion 41b downstream of the circumferential wall 44c and is formed integrally with the circumferential wall 44c. The diffuser plate 42c is formed integrally with the tongue portion 43 of the scroll casing 40 and faces the extension plate 42b. The diffuser plate 42c is formed at a predetermined angle formed with the extension plate 42b such that the cross-sectional area of the flow passage gradually increases along a direction of flow of air through the discharge portion 42.

The first side plate portion 42d is formed integrally with the first side wall 44a1 of the scroll casing 40, and the second side plate portion 42e is formed integrally with the second side wall 44a2 of the scroll casing 40 opposite to the first side wall 44a1. Moreover, the first side plate portion 42d and the second side plate portion 42e are formed between the extension plate 42b and the diffuser plate 42c. Thus, the discharge portion 42 has a rectangular cross-section flow passage defined by the extension plate 42b, the diffuser plate 42c, the first side plate portion 42d, and the second side plate portion 42e.

### (Tongue Portion 43)

In the scroll casing 40, the tongue portion 43 is formed between the diffuser plate 42c of the discharge portion 42 and the scroll start portion 41a of the circumferential wall 44c. The tongue portion 43 is formed with a predetermined radius of curvature, and the circumferential wall 44c is smoothly connected to the diffuser plate 42c through the tongue portion 43.

The tongue portion 43 reduces inflow of air from the scroll end to the scroll start of a scroll flow passage. The tongue portion 43 is located in an upstream part of a ventilation flue, and has a role to effect diversion into a flow of air in the direction of rotation R of the impeller 10 and a flow of air in a discharge direction from a downstream part of the ventilation flue toward the discharge port 42a. Further, a flow of air flowing into the discharge portion 42 rises in static pressure during passage through the scroll casing 40 and is higher in pressure than in the scroll casing 40. Therefore, the tongue portion 43 is formed such that the tongue portion 43 separates such different pressures from each other.

### [Impeller 10]

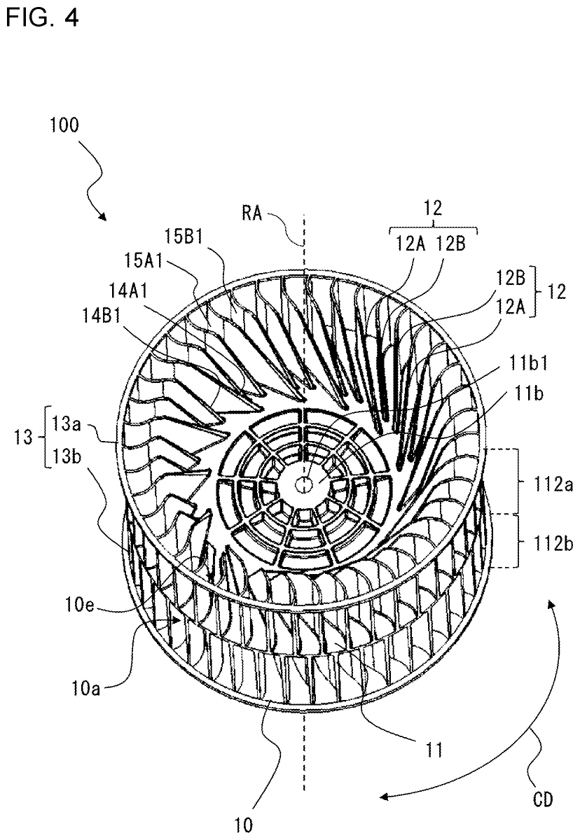

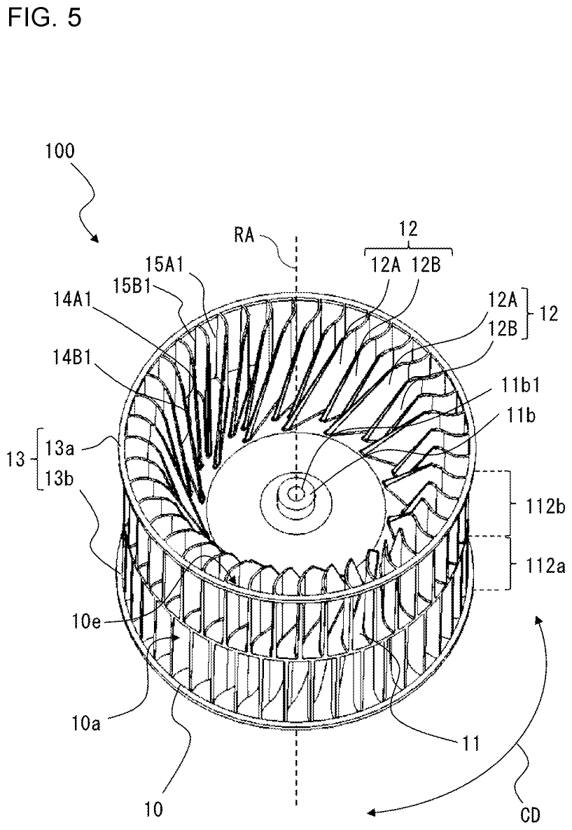

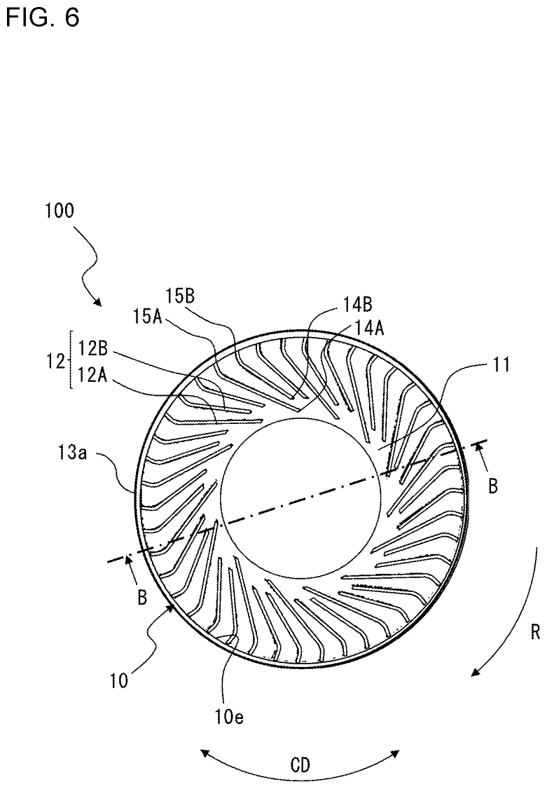

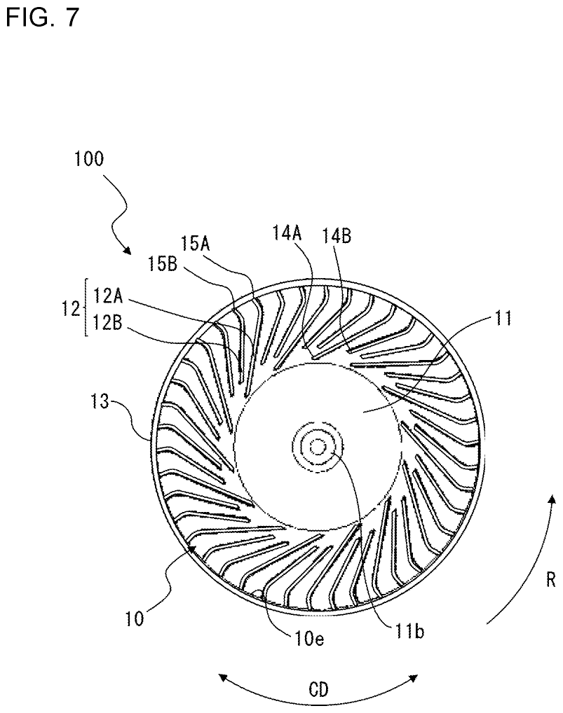

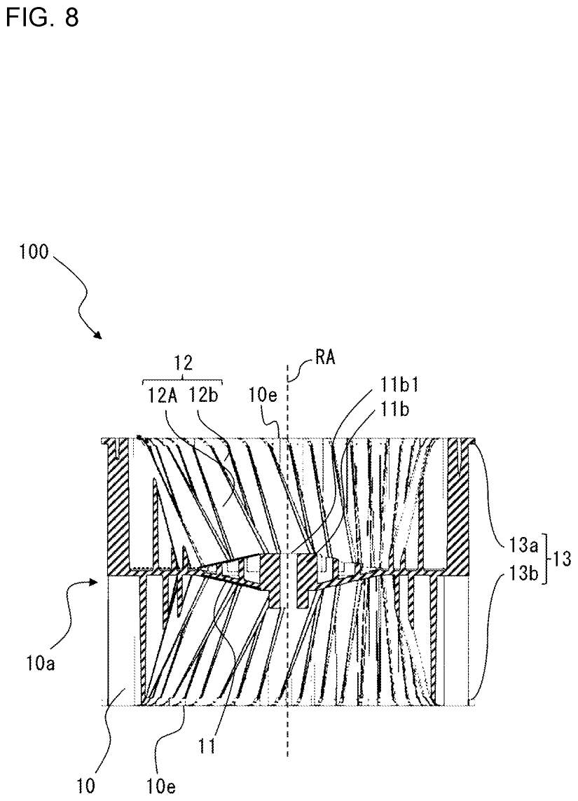

FIG. 4 is a perspective view of the impeller 10 of the centrifugal air-sending device 100 according to Embodiment 1. FIG. 5 is a perspective view of an opposite side of the impeller shown in FIG. 4. FIG. 6 is a plan view of the impeller 10 of the centrifugal air-sending device 100 according to Embodiment 1 from one side of the main plate 11. FIG. 7 is a plan view of the impeller 10 of the centrifugal air-sending device 100 according to Embodiment 1 from the other side of the main plate 11. FIG. 8 is a cross-sectional view of the impeller 10 as taken along line B-B in FIG. 6. It should be noted that FIG. 6 omits to illustrate a detailed configuration of the main plate 11 around the boss portion 11b. The impeller 10 is described with reference to FIGS. 4 to 8.

The impeller 10 is a centrifugal fan. The impeller 10 is connected to a motor (not illustrated) having a drive shaft. The impeller 10 is driven into rotation, for example, by the motor. The rotation generates a centrifugal force with which the impeller 10 forcibly sends out air outward in a radial direction. The impeller 10 is rotated, for example, by the motor in a direction of rotation R indicated by an arrow. As shown in FIG. 4, the impeller 10 includes the main plate 11 having a disk shape, side plates 13 that are annularly shaped, and the plurality of blades 12 arranged in a radial fashion centered around the rotation axis RA on a circumferential edge portion of the main plate 11.

### (Main Plate 11)

The main plate 11 need only be in the shape of a plate, and may for example have a non-disk shape such as a polygonal shape. Further, the main plate 11 may be formed such that as shown in FIG. 3, the thickness of the main plate 11 increases toward the center in radial directions that start from the rotation axis RA as a radial center, or may be formed such that the thickness is uniform in the radial directions starting from the rotation axis RA as a radial center. Further, instead of being formed by one plate-shaped element, the main plate 11 may be formed by a plurality of plate-shaped elements integrally fixed to each other.

The main plate 11 has, in its central part, the boss portion 11b to which the drive shaft of the motor is connected. The boss portion 11b has a shaft hole 11b1 into which the drive shaft of the motor is inserted. Although the boss portion 11b is formed in a cylindrical shape, the shape of the boss portion 11b is not limited to the cylindrical shape. The boss portion 11b need only be formed in a columnar shape, and may for example be formed in a polygonal columnar shape. The main plate 11 is driven into rotation by the motor via the boss portion 11b.

### (Side Plate 13)

The annular side plates 13 of the impeller 10 are attached to respective sets of end portions of the plurality of blades 12 opposite to the main plate 11 in the axial direction of the rotation axis RA of the boss portion 11b. The side plate 13 is provided on an outer circumferential side surface 10a of the impeller 10, and in the impeller 10, the side plate 13 is placed such that the side plate 13 faces the main plate 11. The side plate 13 is provided further outward than are the blades 12 in the radial directions starting from the rotation axis RA as a radial center. The side plate 13 forms the air inlet 10e of the impeller 10 through which gas is sucked. The side plate 13 couples the plurality of blades 12 with each other, thereby maintaining a positional relationship between the tip of each blade 12 and the tip of the other blade 12 and reinforcing the plurality of blades 12.

The side plate 13 includes the annular first side plate 13a placed such that the first side plate 13a faces the main plate 11 and the annular second side plate 13b placed such that the second side plate 13b faces the main plate 11 and placed opposite to a position at which the first side plate 13a is placed across the main plate 11. It should be noted that the side plate 13 is a generic name for the first side plate 13a and the second side plate 13b, and the impeller 10 has the first side plate 13a on one side of the main plate 11 in the axial direction of the rotation axis RA, and has the second side plate 13b on the other side.

### (Blades 12)

As shown in FIG. 4, the plurality of blades 12 are arranged in a circumferential direction CD centered around a rotation axis RA of the main plate 11 that is virtually drawn. One end of each of the plurality of blades 12 is connected to the main plate 11, and the other end of each of the plurality of blades 12 is connected to the corresponding one of the side plates 13. Each of the plurality of blades 12 is disposed between the main plate 11 and the corresponding side plate 13. The plurality of blades 12 are provided on both sides of the main plate 11 in the axial direction of the rotation axis RA of the boss portion 11b. The blades 12 are placed at regular spacings from each other in the circumferential direction CD on the circumferential edge portion of the main plate 11.

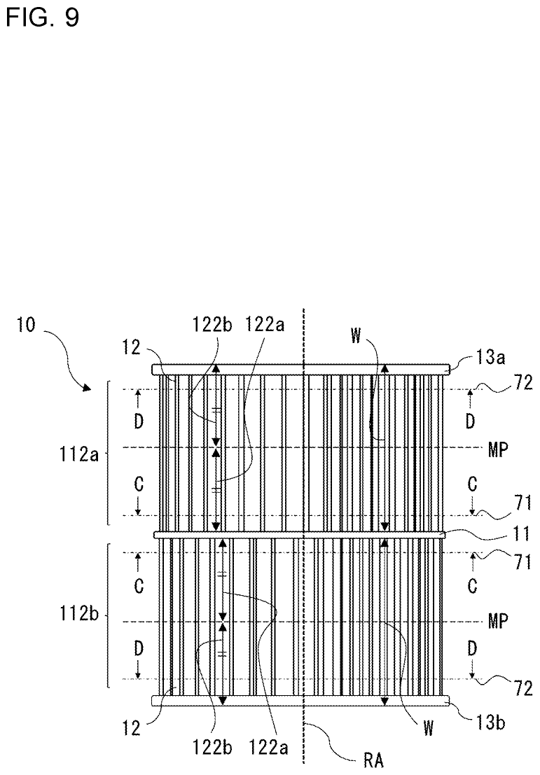

FIG. 9 is a side view of the impeller 10 shown in FIG. 4. As shown in FIGS. 4 and 9, the impeller 10 includes a first air-sending portion 112a and a second air-sending portion 112b. The first air-sending portion 112a and the second air-sending portion 112b are each formed by a plurality of blades 12 and the corresponding side plate 13. More specifically, the first air-sending portion 112a is formed by the annular first side plate 13a and a plurality of blades 12 disposed between the main plate 11 and the first side plate 13a. The second air-sending portion 112b is formed by the annular second side plate 13b and a plurality of blades 12 disposed between the main plate 11 and the second side plate 13b.

The first air-sending portion 112a is disposed on one plate side of the main plate 11, and the second air-sending portion 112b is disposed on the other plate side of the main plate 11. That is, the plurality of blades 12 are provided on both sides of the main plate 11 in the axial direction of the rotation axis RA, and the first air-sending portion 112a and the second air-sending portion 112b are provided back to back with each other across the main plate 11. It should be noted that in FIGS. 4 and 9, the first air-sending portion 112a is disposed higher than the main plate 11 and the second air-sending portion 112b is disposed lower than the main plate 11. However, the first air-sending portion 112a and the second air-sending portion 112b need only be provided back to back with each other, and the first air-sending portion 112a may be disposed lower than the main plate 11 and the second air-sending portion 112b is disposed higher than the main plate 11. In the following description, those blades 12 that form the first air-sending portion 112a and those blades 12 that form the second air-sending portion 112b are collectively referred to as “blades 12” unless otherwise noted.

As shown in FIGS. 4 and 5, the impeller 10 is formed in a tubular shape by the plurality of blades 12 disposed on the main plate 11. Moreover, the impeller 10 has air inlets 10e formed in the respective vicinities of the side plates 13, which are each opposite to the main plate 11 in the axial direction of the rotation axis RA of the boss portion 11b. The air inlet 10e causes gas to flow into a space surrounded by the main plate 11 and the plurality of blades 12. The impeller 10 has its blades 12 and side plates 13 disposed on both respective sides of a plate that corresponds to the main plate 11, and has its air inlets 10e formed on both respective sides of the plate, which corresponds to the main plate 11.

The impeller 10 is driven into rotation around the rotation axis RA by driving of the motor (not illustrated). The rotation of the impeller 10 causes gas outside the centrifugal air-sending device 100 to be sucked into the space surrounded by the main plate 11 and the plurality of blades 12 through the case air inlet 45 formed in the scroll casing 40 shown in FIG. 1 and the air inlets 10e of the impeller 10. Moreover, the rotation of the impeller 10 causes air sucked into the space surrounded by the main plate 11 and the plurality of blades 12 to be sent out outward in radial directions of the impeller 10 through a space between each blade 12 and an adjacent blade 12.

### (Configuration of Blades 12 in Detail)

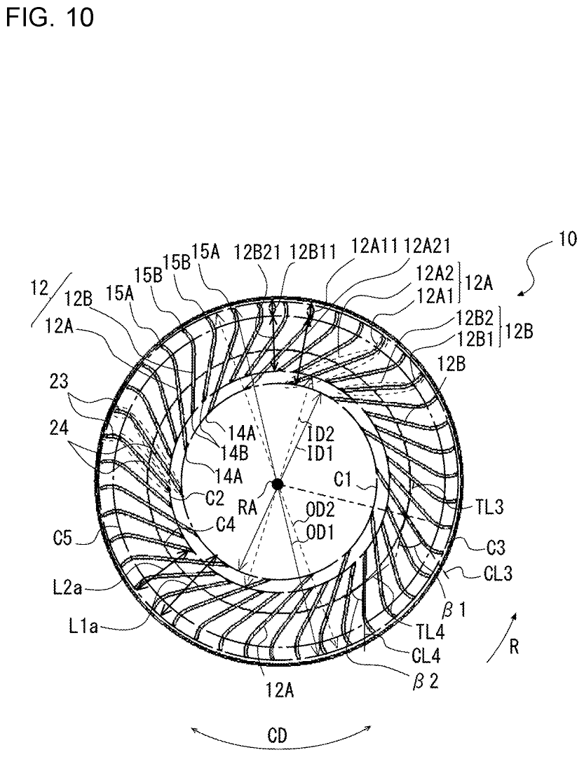

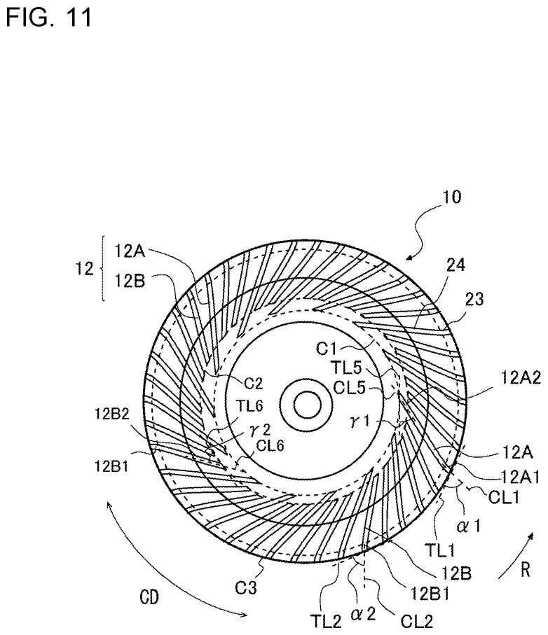

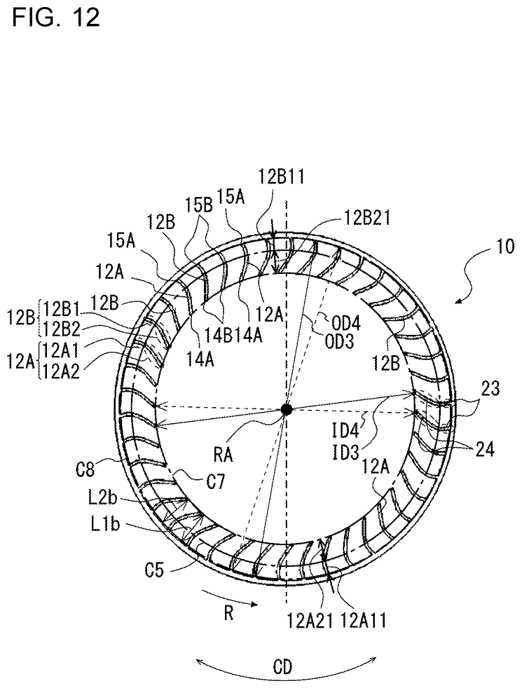

FIG. 10 is a schematic view showing blades 12 in a cross-section of the impeller 10 as taken along line C-C in FIG. 9. FIG. 11 is a schematic view showing an outlet angle of a blade 12 in the cross-section of the impeller 10 as taken along line C-C in FIG. 9. FIG. 12 is a schematic view showing blades 12 in a cross-section of the impeller 10 as taken along line D-D in FIG. 9. In FIG. 9, a middle point MP of the impeller 10 indicates a middle point in the axial direction of the rotation axis RA in the plurality of blades 12 of the first air-sending portion 112a. Further, in FIG. 9, the middle point MP of the impeller 10 indicates a middle point in the axial direction of the rotation axis RA in the plurality of blades 12 of the second air-sending portion 112b.

In the plurality of blades 12 of the first air-sending portion 112a, a region from the middle point MP in the axial direction of the rotation axis RA to the main plate 11 is a main-plate-side blade region 122a serving as a first region of the impeller 10. Further, in the plurality of blades 12 of the first air-sending portion 112a, a region from the middle point MP in the axial direction of the rotation axis RA to an end portion of the side plate 13 is a side-plate-side blade region 122b serving as a second region of the impeller 10. That is, each of the plurality of blades 12 has a first region located closer to the main plate 11 than is the middle point MP in the axial direction of the rotation axis RA and a second region located closer to the side plate 13 than is the first region.

As shown in FIG. 10, the cross-section taken along line C-C in FIG. 9 is a cross-section of parts of the plurality of blades 12 that are close to the main plate 11 of the impeller 10, that is, that are in the main-plate-side blade region 122a serving as the first region. This cross-section of the parts of the blades 12 that are close to the main plate 11 is a first plane 71 perpendicular to the rotation axis RA and a first cross-section of the impeller 10 made by cutting through a portion of the impeller 10 close to the main plate 11. Note here that the portion of the impeller 10 close to the main plate 11 is for example a portion of the impeller 10 closer to the main plate 11 than is a middle point of the main-plate-side blade region 122a in the axial direction of the rotation axis RA or a portion of the impeller 10 in which end portions of the blades 12 that are close to the main plate 11 are located in the axial direction of the rotation axis RA.

As shown in FIG. 9, the cross-section taken along line D-D in FIG. 12 is a cross-section of parts of the plurality of blades 12 that are close to each of the side plates 13 of the impeller 10, that is, that are in the side-plate-side blade region 122b serving as the second region. This cross-section of the parts of the blades 12 that are close to the side plate 13 is a second plane 72 perpendicular to the rotation axis RA and a second cross-section of the impeller 10 made by cutting through a portion of the impeller 10 close to the side plate 13. Note here that the portion of the impeller 10 close to the side plate 13 is for example a portion of the impeller 10 closer to the side plate 13 than is a middle point of the side-plate-side blade region 122b in the axial direction of the rotation axis RA or a portion of the impeller 10 in which end portions of the blades 12 that are close to the side plate 13 are located in the axial direction of the rotation axis RA.

A basic configuration of the blades 12 in the second air-sending portion 112b is similar to a basic configuration of the blades 12 in the first air-sending portion 112a. That is, in the plurality of blades 12 of the second air-sending portion 112b, a region from the middle point MP in the axial direction of the rotation axis RA to the main plate 11 is a main-plate-side blade region 122a serving as a first region of the impeller 10. Further, in the plurality of blades 12 of the second air-sending portion 112b, a region from the middle point MP in the axial direction of the rotation axis RA to an end portion of each of the second side plates 13b is a side-plate-side blade region 122b serving as a second region of the impeller 10.

Although the foregoing description is made on a case in which a basic configuration of the first air-sending portion 112a and a basic configuration of the second air-sending portion 112b are similar to each other, a configuration of the impeller 10 is not limited to such a configuration and may be a configuration in which the first air-sending portion 112a and the second air-sending portion 112b are different from each other. That is, both or either one of the first air-sending portion 112a and the second air-sending portion 112b may have the configuration of the blades 12 described below.

As shown in FIGS. 9 to 12, the plurality of blades 12 include a plurality of first blades 12A and a plurality of second blades 12B. The plurality of blades 12 include an alternate arrangement of a first blade 12A and one or more second blades 12B in the circumferential direction CD of the impeller 10.

As shown in FIGS. 9 to 12, the impeller 10 is formed such that two second blades 12B are disposed between a first blade 12A and another first blade 12A placed next to the first blade 12A in the direction of rotation R. Note, however, that the number of second blades 12B that are disposed between a first blade 12A and another first blade 12A placed next to the first blade 12A in the direction of rotation R is not limited to two and may be one or larger than or equal to three. That is, at least one among the plurality of second blades 12B is disposed between two among the plurality of first blades 12A adjacent to each other in the circumferential direction CD.

As shown in FIG. 10, each of the first blades 12A has an inner circumferential end 14A and an outer circumferential end 15A in the first cross-section of the impeller 10 as taken along the first plane 71 perpendicular to the rotation axis RA. The inner circumferential end 14A is located close to the rotation axis RA in a radial direction that starts from the rotation axis RA as a radial center, and the outer circumferential end 15A is located closer to an outer circumference than is the inner circumferential end 14A in the radial direction. In each of the plurality of first blades 12A, the inner circumferential end 14A is disposed further forward than is the outer circumferential end 15A in the direction of rotation R of the impeller 10.

As shown in FIG. 4, the inner circumferential end 14A serves as a leading edge 14A1 of the first blade 12A, and the outer circumferential end 15A serves as a trailing edge 15A1 of the first blade 12A. As shown in FIG. 10, the impeller 10 has fourteen first blades 12A disposed in the impeller 10. However, the number of first blades 12A is not limited to 14 and may be smaller or larger than 14.

As shown in FIG. 10, each of the second blades 12B has an inner circumferential end 14B and an outer circumferential end 15B in the first cross-section of the impeller 10 as taken along the first plane 71 perpendicular to the rotation axis RA. The inner circumferential end 14B is located close to the rotation axis RA in a radial direction that starts from the rotation axis RA as a radial center, and the outer circumferential end 15B is located closer to an outer circumference than is the inner circumferential end 14B in the radial direction. In each of the plurality of second blades 12B, the inner circumferential end 14B is disposed further forward than is the outer circumferential end 15B in the direction of rotation R of the impeller 10.

As shown in FIG. 4, the inner circumferential end 14B serves as a leading edge 14B1 of the second blade 12B, and the outer circumferential end 15B serves as a trailing edge 15B1 of the second blade 12B. As shown in FIG. 10, the impeller 10 has twenty-eight second blades 12B disposed in the impeller 10. However, the number of second blades 12B is not limited to 28 and may be smaller or larger than 28.

The following describes a relationship between the first blades 12A and the second blades 12B. As shown in FIGS. 4 and 12, the first blades 12A and the second blades 12B are formed such that the vane length of each of the first blades 12A becomes gradually more equal to the vane length of each of the second blades 12B from the middle points MP toward the first side plate 13a and the second side plate 13b in a direction along the rotation axis RA.

Meanwhile, as shown in FIGS. 4 and 10, the vane length of a portion of each of the first blades 12A closer to the main plate 11 than is the middle point MP in the direction along the rotation axis RA is greater than the vane length of a portion of each of the second blades 12B closer to the main plate 11 than is the middle point MP in the direction along the rotation axis RA, and increases toward the main plate 11. Thus, in the present embodiment, the vane length of at least a portion of each of the first blades 12A in the direction along the rotation axis RA is greater than the vane length of at least a portion of each of the second blades 12B in the direction along the rotation axis RA. It should be noted that the term “vane length” here means the length of each of the first blades 12A in a radial direction of the impeller 10 and the length of each of the second blades 12B in a radial direction of the impeller 10.

As shown in FIG. 10, in the first cross-section closer to the main plate 11 than is the middle point MP shown in FIG. 9, the diameter of a circle C1 passing through the inner circumferential ends 14A of the plurality of first blades 12A around the rotation axis RA, that is, the inside diameter of the first blades 12A, is defined as an inside diameter ID1. The diameter of a circle C3 passing through the outer circumferential ends 15A of the plurality of first blades 12A around the rotation axis RA, that is, the outside diameter of the first blades 12A, is defined as an outside diameter OD1. One-half of the difference between the outside diameter OD1 and the inside diameter ID1 is equal to the vane length L1a of each of the first blades 12A in the first cross-section (Vane Length L1a=(Outside Diameter OD1−Inside Diameter ID1)/2).

Note here that the ratio between the inside diameter of the first blades 12A and the outside diameter of the first blades 12A is lower than or equal to 0.7. That is, the plurality of first blades 12A are formed such that the ratio between the inside diameter ID1 defined by the inner circumferential ends 14A of the plurality of first blades 12A and the outside diameter OD1 defined by the outer circumferential ends 15A of the plurality of first blades 12A is lower than or equal to 0.7.

It should be noted that in a common centrifugal air-sending device, the vane length of a blade in a cross-section perpendicular to a rotation axis is shorter than the width dimension of a blade in a direction parallel with the rotation axis. In the present embodiment too, the maximum possible vane length of each of the first blades 12A, that is, the vane length of an end portion of each of the first blades 12A close to the main plate 11, is shorter than the width dimension W (see FIG. 9) of each of the first blades 12A in the direction parallel with the rotation axis.

Further, in the first cross-section, the diameter of a circle C2 passing through the inner circumferential ends 14B of the plurality of second blades 12B around the rotation axis RA, that is, the inside diameter of the second blades 12B, is defined as an inside diameter ID2 that is larger than the inside diameter ID1 (Inside Diameter ID2>Inside Diameter ID1). The diameter of the circle C3 passing through the outer circumferential ends 15B of the plurality of second blades 12B around the rotation axis RA, that is, the outside diameter of the second blades 12B, is defined as an outside diameter OD2 that is equal to the outside diameter OD1 (Outside Diameter OD2=Outside Diameter OD1). One-half of the difference between the outside diameter OD2 and the inside diameter ID2 is equal to the vane length L2a of each of the second blades 12B in the first cross-section (Vane Length L2a=(Outside Diameter OD2−Inside Diameter ID2)/2). The vane length L2a of each of the second blades 12B in the first cross-section is shorter than the vane length L1a of each of the first blades 12A in the same cross-section (Vane Length L2a<Vane Length L1a).

Note here that the ratio between the inside diameter of the second blades 12B and the outside diameter of the second blades 12B is lower than or equal to 0.7. That is, the plurality of second blades 12B are formed such that the ratio between the inside diameter ID2 defined by the inner circumferential ends 14B of the plurality of second blades 12B and the outside diameter OD2 defined by the outer circumferential ends 15B of the plurality of second blades 12B is lower than or equal to 0.7.

Meanwhile, as shown in FIG. 12, in the second cross-section closer to each of the side plates 13 than is the corresponding one of the middle points MP shown in FIG. 9, the diameter of a circle C7 passing through the inner circumferential ends 14A of the first blades 12A around the rotation axis RA is defined as an inside diameter ID3. The inside diameter ID3 is larger than the inside diameter ID1 of the first cross-section (Inside Diameter ID3>Inside Diameter ID1). The diameter of a circle C8 passing through the outer circumferential ends 15A of the first blades 12A around the rotation axis RA is defined as an outside diameter OD3. One-half of the difference between the outside diameter OD3 and the inside diameter ID3 is equal to the vane length L1b of each of the first blades 12A in the second cross-section (Vane Length L1b=(Outside Diameter OD3−Inside Diameter ID3)/2).

Further, in the second cross-section, the diameter of the circle C7 passing through the inner circumferential ends 14B of the second blades 12B around the rotation axis RA is defined as an inside diameter ID4. The inside diameter ID4 is equal to the inside diameter ID3 in the same cross-section (Inside Diameter ID4=Inside Diameter ID3). The diameter of the circle C8 passing through the outer circumferential ends 15B of the second blades 12B around the rotation axis RA is defined as an outside diameter OD4. The outside diameter OD4 is equal to the outside diameter OD3 in the same cross-section (Outside Diameter OD4=Outside Diameter OD3). One-half of the difference between the outside diameter OD4 and the inside diameter ID4 is equal to the vane length L2b of each of the second blades 12B in the second cross-section (Vane Length L2b=(Outside Diameter OD4−Inside Diameter ID4)/2). The vane length L2b of each of the second blades 12B in the second cross-section is equal to the vane length L1b of each of the first blades 12A in the same cross-section (Vane Length L2b=Vane Length L1b).

When viewed from an angle parallel with the rotation axis RA, the first blades 12A in the second cross-section shown in FIG. 12 overlap the first blades 12A in the first cross-section shown in FIG. 10 such that the former first blades 12A do not stick out from the contour defined by the latter first blades 12A. For this reason, the impeller 10 satisfies the relationships “Outside Diameter OD3=Outside Diameter OD1”, “Inside Diameter ID3>Inside Diameter ID1”, and “Vane Length L1b≤Vane Length L1a”.

Similarly, when viewed from an angle parallel with the rotation axis RA, the second blades 12B in the second cross-section shown in FIG. 12 overlap the second blades 12B in the first cross-section shown in FIG. 10 such that the former second blades 12B do not stick out from the contour defined by the latter second blades 12B. For this reason, the impeller 10 satisfies the relationships “Outside Diameter OD4=Outside Diameter OD2”, “Inside Diameter ID4≥Inside Diameter ID2”, and “Vane Length L2b≤Vane Length L2a”.

Note here that as mentioned above, the ratio between the inside diameter ID1 of the first blades 12A and the outside diameter OD1 of the first blades 12A is lower than or equal to 0.7. Since the blades 12 are formed such that Inside Diameter ID3≥Inside Diameter ID1, Inside Diameter ID4≥Inside Diameter ID2, and Inside Diameter ID2>Inside Diameter ID1, the inside diameter of the first blades 12A is defined as a blade inside diameter of the blades 12. Further, since the blades 12 are formed such that Outside Diameter OD3=Outside Diameter OD1, Outside Diameter OD4=Outside Diameter OD2, and Outside Diameter OD2=Outside Diameter OD1, the outside diameter of the first blades 12A is defined as a blade outside diameter of the blades 12. Moreover, in a case in which the blades 12 of the impeller 10 are seen as a whole, the blades 12 are formed such that the ratio between the blade inside diameter of the blades 12 and the blade outside diameter of the blades 12 is lower than or equal to 0.7.

It should be noted that the blade inside diameter of the plurality of blades 12 is defined by the inner circumferential ends of the plurality of blades 12. That is, the blade inside diameter of the plurality of blades 12 is defined by the leading edges 14A1 of the plurality of blades 12. Further, the blade outside diameter of the plurality of blades 12 is defined by the outer circumferential ends of the plurality of blade 12. That is, the blade outside diameter of the plurality of blades 12 is defined by the trailing edges 15A1 and 15B1 of the plurality of blades 12.

### (Configuration of First Blades 12A and Second Blades 12B)

In a comparison between the first cross-section shown in FIG. 10 and the second cross-section shown in FIG. 12, each of the first blades 12A has the relationship “Vane Length L1a>Vane Length L1b”. That is, each of the plurality of blades 12 has a portion formed such that a vane length in the first region is longer than a vane length in the second region. More specifically, each of the first blades 12A is formed such that the vane length decreases from the main plate 11 toward the corresponding one of the side plates 13 in the axial direction of the rotation axis RA.

Similarly, in a comparison between the first cross-section shown in FIG. 10 and the second cross-section shown in FIG. 12, each of the second blades 12B has the relationship “Vane Length L2a>Vane Length L2b”. That is, each of the second blades 12B has a portion formed such that the vane length decreases from the main plate 11 toward the corresponding one of the side plates 13 in the axial direction of the rotation axis RA. That is, each of the plurality of blades 12 is formed such that the vane length decreases from the main plate 11 toward the corresponding side plate 13. Each of the plurality of blades 12 is shaped such that the vane length continuously changes in size from the main plate 11 toward the corresponding side plate 13. It should be noted that the shapes of the plurality of blades 12 are not limited to such shapes, and the plurality of blades 12 may have portions in which their vane lengths are constant in size between the main plate 11 and the corresponding side plate 13. That is, the plurality of blades 12 may have portions in which the inside diameter ID is constant and is not inclined to the rotation axis RA.

As shown in FIG. 4, the leading edges of the first blades 12A and the second blades 12B are inclined such that the blade inside diameter increases from the main plate 11 toward the corresponding side plate 13. That is, the plurality of blades 12 have inclined portions 141A inclined such that the inner circumferential ends 14A forming the leading edges 14A1 extend away from the rotation axis RA and the blade inside diameter increases from the main plate 11 toward the corresponding side plate 13. Similarly, the plurality of blades 12 have inclined portions 141B inclined such that the inner circumferential ends 14B forming the leading edges 14B1 extend away from the rotation axis RA and the blade inside diameter increases from the main plate 11 toward the corresponding side plate 13.

### (Outer Circumferential Vane Portion and Inner Circumferential Vane Portion)

As shown in FIGS. 10 and 12, each of the first blades 12A has a first outer circumferential vane portion 12A1 including the outer circumferential end 15A and a first inner circumferential vane portion 12A2 including the inner circumferential end 14A and being formed as a backward-curved blade including a turbo vane that forms the backward-curved blade. In a radial direction of the impeller 10, the first outer circumferential vane portion 12A1 forms an outer circumference side portion of the first blade 12A, and the first inner circumferential vane portion 12A2 forms an inner circumference side portion of the first blade 12A. That is, each of the first blades 12A is formed such that the first inner circumferential vane portion 12A2 and the first outer circumferential vane portion 12A1 are arranged in this order from the rotation axis RA toward the outer circumference in the radial direction of the impeller 10.

In each of the first blades 12A, the first inner circumferential vane portion 12A2 and the first outer circumferential vane portion 12A1 are integrally formed. The first inner circumferential vane portion 12A2 forms the leading edge 14A1 of the first blade 12A, and the first outer circumferential vane portion 12A1 forms the trailing edge 15A1 of the first blade 12A. In the radial direction of the impeller 10, the first inner circumferential vane portion 12A2 extends from the inner circumferential end 14A forming the leading edge 14A1 toward the outer circumference.

In a radial direction of the impeller 10, a region of the first outer circumferential vane portion 12A1 of each of the first blades 12A is defined as a first outer circumferential region 12A11, and a region of the first inner circumferential vane portion 12A2 of each of the first blades 12A is defined as a first inner circumferential region 12A21. In the radial direction of the impeller 10, each of the first blades 12A has a portion in which the first inner circumferential region 12A21 is larger than the first outer circumferential region 12A11.

In the main-plate-side blade region 122a serving as the first region and the side-plate-side blade region 122b serving as the second region as shown in FIG. 9, the impeller 10 includes, in a radial direction of the impeller 10, a portion having the relationship “First Outer Circumferential region 12A11<First Inner Circumferential Region 12A21”. In the main-plate-side blade region 122a serving as the first region and the side-plate-side blade region 122b serving as the second region, each of the first blades 12A has, in the radial direction of the impeller 10, a portion in which a ratio of the first inner circumferential vane portion 12A2 is larger than a ratio of the first outer circumferential vane portion 12A1.

Similarly, as shown in FIGS. 10 and 12, each of the second blades 12B has a second outer circumferential vane portion 12B1 including the outer circumferential end 15B and a second inner circumferential vane portion 12B2 including the inner circumferential end 14B and being formed as a backward-curved blade including a turbo vane that forms the backward-curved blade. In a radial direction of the impeller 10, the second outer circumferential vane portion 12B1 forms an outer circumference side portion of the second blade 12B, and the second inner circumferential vane portion 12B2 forms an inner circumference side portion of the second blade 12B. That is, each of the second blades 12B is formed such that the second inner circumferential vane portion 12B2 and the second outer circumferential vane portion 12B1 are arranged in this order from the rotation axis RA toward the outer circumference in the radial direction of the impeller 10.

In each of the second blades 12B, the second inner circumferential vane portion 12B2 and the second outer circumferential vane portion 12B1 are integrally formed. The second inner circumferential vane portion 12B2 forms the leading edge 14B1 of the second blade 12B, and the second outer circumferential vane portion 12B1 forms the trailing edge 15B1 of the second blade 12B. In the radial direction of the impeller 10. the second inner circumferential vane portion 12B2 extends from the inner circumferential end 14B forming the leading edge 14B1 toward the outer circumference.

In a radial direction of the impeller 10, a region of the second outer circumferential vane portion 12B1 of each of the second blades 12B is defined as a second outer circumferential region 12B11, and a region of the second inner circumferential vane portion 12B2 of each of the second blades 12B is defined as a second inner circumferential region 12B21. In the radial direction of the impeller 10, each of the second blades 12B has a portion in which the second inner circumferential region 12B21 is larger than the second outer circumferential region 12B11.

In the main-plate-side blade region 122a serving as the first region and the side-plate-side blade region 122b serving as the second region as shown in FIG. 9, the impeller 10 includes, in a radial direction of the impeller 10, a portion having the relationship “Second Outer Circumferential region 12B11<Second Inner Circumferential Region 12B21”. In the main-plate-side blade region 122a serving as the first region and the side-plate-side blade region 122b serving as the second region, each of the second blades 12B has, in the radial direction of the impeller 10, a portion in which a ratio of the second inner circumferential vane portion 12B2 is larger than a ratio of the second outer circumferential vane portion 12B1.

Because of the foregoing configuration, in the main-plate-side blade region 122a and the side-plate-side blade region 122b, each of the plurality of blades 12 has, in the radial direction of the impeller 10, a portion in which a region of the inner circumferential vane portion is larger than a region of the outer circumferential vane portion. That is, in the main-plate-side blade region 122a and the side-plate-side blade region 122b, each of the plurality of blades 12 has, in the radial direction of the impeller 10, a portion in which a ratio of the inner circumferential vane portion is larger than a ratio of the outer circumferential vane portion and that has the relationship “Inner Circumferential Region<Outer Circumferential Region”. In other words, each of the plurality of blades 12 is formed such that in the first region and the second region, a ratio of the inner circumferential vane portion in the radial direction is larger than a ratio of the outer circumferential vane portion in the radial direction. The relationship between the ratio of the outer circumferential vane portion and the ratio of the inner circumferential vane portion in the radial direction of the rotation axis RA may hold in both the main-plate-side blade region 122a serving as the first region and the side-plate-side blade region 122b serving as the second region.

It should be noted that the plurality of blades 12 are not limited to being formed such that in both the main-plate-side blade region 122a and the side-plate-side blade region 122b, a ratio of the inner circumferential vane portion in a radial direction of the impeller 10 is larger than a ratio of the outer circumferential vane portion in the radial direction of the impeller 10. Each of the plurality of blades 12 may be formed such that in the first region and the second region, a ratio of the inner circumferential vane portion in a radial direction is smaller than or equal to a ratio of the outer circumferential vane portion in the radial direction.

### (First Vane Portion 23 and Second Vane Portion 24)

The impeller 10 includes first vane portions 23 and second vane portions 24. Each of the first vane portions 23 is composed of a first outer circumferential vane portion 12A1 or a second outer circumferential vane portion 12B1. The first vane portion 23 is connected to the corresponding one of the side plates 13. The first vane portion 23 forms a blade 12 that includes an outer circumferential end 15A or an outer circumferential end 15B and is formed such that outlet angles α1 and α2, which are described later, are each formed at 90 degrees or less. In a case in which the outlet angles α1 and α2 are each less than 90 degrees, the first vane portion 23 forms a turbo vane that forms a backward-curved blade. In a case in which the outlet angles α1 and α2 are each 90 degrees, the first vane portion 23 is formed as a radial vane that linearly extends in a radial direction of the impeller 10. That is, the first outer circumferential vane portion 12A1 is formed by a turbo vane portion or a radial vane portion. Similarly, the second outer circumferential vane portion 12B1 is formed by a turbo vane portion or a radial vane portion.

Further, each of the second vane portions 24 is composed of a first inner circumferential vane portion 12A2 or a second inner circumferential vane portion 12B2.

That is, the second vane portion 24 is a portion of the impeller 10 that includes a turbo vane. The second vane portion 24 includes an inner circumferential end 14A or an inner circumferential end 14B, a turbo vane that forms a backward-curved blade, and a portion of the blade 12 close to the main plate 11 in an axial direction of the rotation axis RA that protrudes further inward than the bell mouth 46 when the second vane portion 24 is viewed in the axial direction of the rotation axis RA.

The first vane portion 23 and the second vane portion 24 are each bent and thus include at least one arc-shaped portion when the first vane portion 23 and the second vane portion 24 are viewed in the axial direction of the rotation axis RA. The first vane portion 23 and the second vane portion 24 are formed such that a radius of curvature of the first vane portion 23 is smaller than a radius of curvature of the second vane portion 24.

The shape of the second vane portion 24 is not limited to a shape bent as noted above. The first vane portion 23 may be bent and thus include at least one arc-shaped portion when the first vane portion 23 is viewed in the axial direction of the rotation axis RA, and the second vane portion 24 may be linearly formed when the second vane portion 24 is viewed in the axial direction of the rotation axis RA.

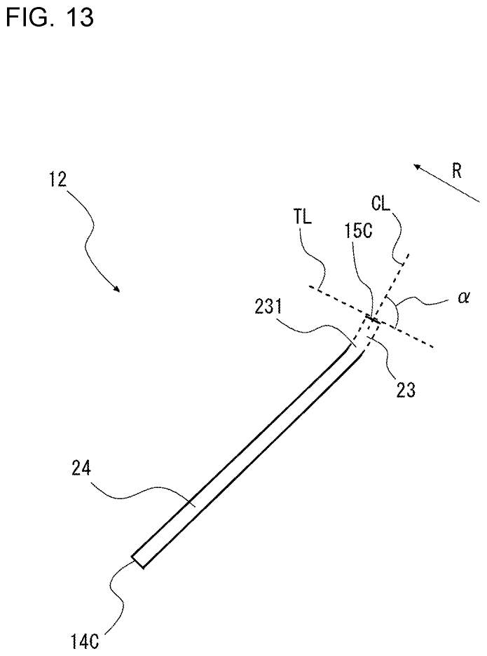

FIG. 13 is an enlarged view conceptually showing a first example of a blade 12 of the centrifugal air-sending device 100 according to Embodiment 1. The blade 12 of the first example is described with reference to FIG. 13. The blade 12 may be either a first blade 12A or a second blade 12B, and is a generic name for the first blade 12A and the second blade 12B. Further, the inner circumferential end 14C is a generic name for the inner circumferential end 14A of the first blade 12A and the inner circumferential end 14B of the second blade 12B. Further, the outer circumferential end 15C is a generic name for the outer circumferential end 15A of the first blade 12A and the outer circumferential end 15B of the second blade 12B. Further, the outlet angle α is a generic name for the α1 and α2, which are described later.

The blade 12 includes a first vane portion 23 and a second vane portion 24. In a case in which the outlet angle α is less than 90 degrees, the first vane portion 23 has a portion that forms a turbo vane that forms a backward-curved blade. In a case in which the outlet angle α is 90 degrees, the first vane portion 23 has a portion formed as a radial vane that linearly extends in a radial direction of the impeller 10. The first vane portion 23 includes an outer circumferential first arc portion 231. The outer circumferential first arc portion 231 is an arc-shaped portion when the outer circumferential first arc portion 231 is viewed in the axial direction of the rotation axis RA. The outer circumferential first arc portion 231 is formed and curves out in a direction opposite to the direction of rotation R of the blade 12 and formed open in the direction of rotation R when the outer circumferential first arc portion 231 is viewed in the axial direction of the rotation axis RA. The second vane portion 24 is linearly formed when the second vane portion 24 is viewed in the axial direction of the rotation axis RA.

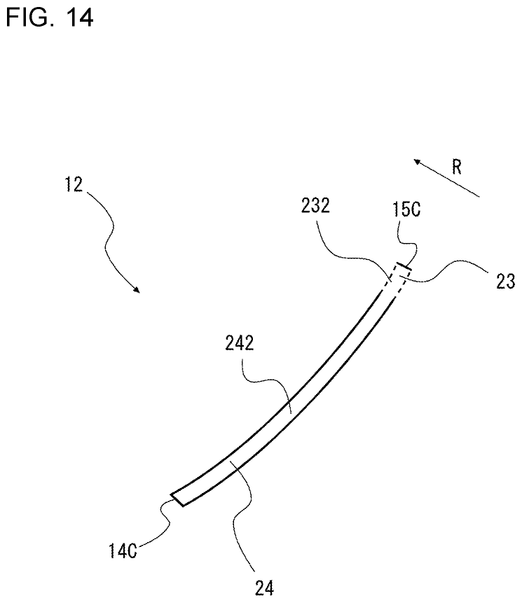

FIG. 14 is an enlarged view conceptually showing a second example of a blade 12 of the centrifugal air-sending device 100 according to Embodiment 1. The blade 12 of the second example is described with reference to FIG. 14. It should be noted that components that are identical in configuration to those of FIG. 13 are given identical reference signs and a description of such components is omitted. The first vane portion 23 includes an outer circumferential first arc portion 232. The outer circumferential first arc portion 232 is an arc-shaped portion when the outer circumferential first arc portion 232 is viewed in the axial direction of the rotation axis RA. The outer circumferential first arc portion 232 is formed and curves out in a direction opposite to the direction of rotation R of the blade 12 and formed open in the direction of rotation R when the outer circumferential first arc portion 232 is viewed in the axial direction of the rotation axis RA.

The second vane portion 24 includes an inner circumferential first arc portion 242. The inner circumferential first arc portion 242 is an arc-shaped portion when the inner circumferential first arc portion 242 is viewed in the axial direction of the rotation axis RA. The inner circumferential first arc portion 242 is formed and curves out in a direction opposite to the direction of rotation R of the blade 12 and formed open in the direction of rotation R when the inner circumferential first arc portion 242 is viewed in the axial direction of the rotation axis RA.

The radius of curvature of the outer circumferential first arc portion 232 is here defined as a radius of curvature r. The radius of curvature of the inner circumferential first arc portion 242 is also defined as a radius of curvature R. The blade 12 of the second example is formed to satisfy the relational expression “Radius of Curvature r>Radius of Curvature R”. That is, the blade 12 of the second example is formed such that the radius of curvature of the outer circumferential first arc portion 232 is larger than the radius of curvature of the inner circumferential first arc portion 242.

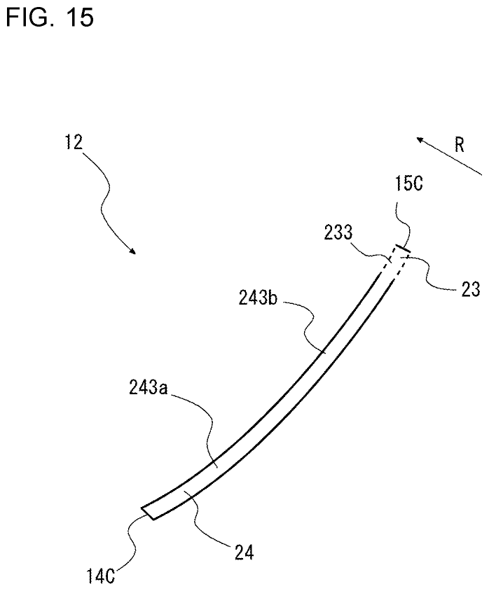

FIG. 15 is an enlarged view conceptually showing a third example of a blade 12 of the centrifugal air-sending device 100 according to Embodiment 1. The blade 12 of the third example is described with reference to FIG. 15. It should be noted that components that are identical in configuration to those of FIG. 13 are given identical reference signs and a description of such components is omitted. The first vane portion 23 includes an outer circumferential first arc portion 233. The outer circumferential first arc portion 233 is an arc-shaped portion when the outer circumferential first arc portion 233 is viewed in the axial direction of the rotation axis RA. The outer circumferential first arc portion 233 is formed and curves out in a direction opposite to the direction of rotation R of the blade 12 and formed open in the direction of rotation R when the outer circumferential first arc portion 233 is viewed in the axial direction of the rotation axis RA.

The second vane portion 24 includes an inner circumferential first arc portion 243a and an inner circumferential second arc portion 243b. The inner circumferential first arc portion 243a is located closer to the rotation axis RA, that is, closer to an inner circumference of the impeller 10, than is the inner circumferential second arc portion 243b. The inner circumferential second arc portion 243b is located closer to the corresponding one of the side plates 13, that is, closer to an outer circumference of the impeller 10, than is the inner circumferential first arc portion 243a.

The inner circumferential first arc portion 243a and the inner circumferential second arc portion 243b are arc-shaped portions when the inner circumferential first arc portion 243a and the inner circumferential second arc portion 243b are viewed in the axial direction of the rotation axis RA. The inner circumferential first arc portion 243a and the inner circumferential second arc portion 243b are formed and curve out in a direction opposite to the direction of rotation R of the blade 12 and formed open in the direction of rotation R when the inner circumferential first arc portion 243a and the inner circumferential second arc portion 243b are viewed in the axial direction of the rotation axis RA.

The radius of curvature of the outer circumferential first arc portion 233 is here defined as a radius of curvature r. The radius of curvature of the inner circumferential first arc portion 243a is also defined as a radius of curvature R1. The radius of curvature of the inner circumferential second arc portion 243b is also defined as a radius of curvature R2. The blade 12 of the third example is formed to satisfy the relational expression “Radius of Curvature r>Radius of Curvature R2>Radius of Curvature R1”. That is, the blade 12 of the third example is formed such that the radius of curvature of the outer circumferential first arc portion 233 is larger than the radius of curvature of the inner circumferential second arc portion 243b and the radius of curvature of the inner circumferential second arc portion 243b is larger than the radius of curvature of the inner circumferential first arc portion 243a. The blade 12 of the third example is formed such that the radius of curvature of an arc-shaped portion increases from the inner circumference toward the outer circumference.

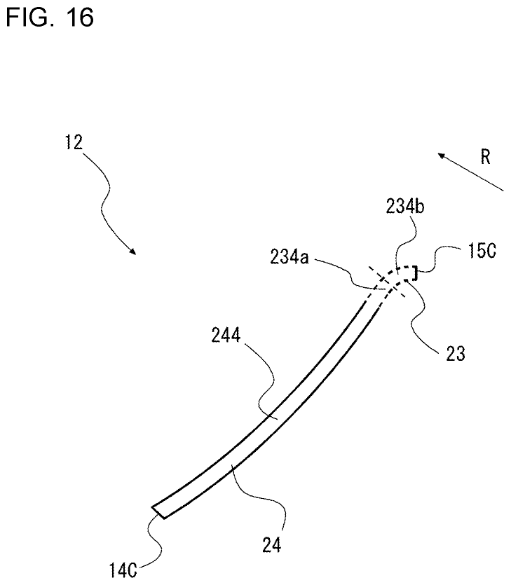

FIG. 16 is an enlarged view conceptually showing a fourth example of a blade 12 of the centrifugal air-sending device 100 according to Embodiment 1. The blade 12 of the fourth example is described with reference to FIG. 16. It should be noted that components that are identical in configuration to those of FIG. 13 are given identical reference signs and a description of such components is omitted. The first vane portion 23 includes an outer circumferential first arc portion 234a and an outer circumferential second arc portion 234b. The outer circumferential first arc portion 234a is located closer to the rotation axis RA, that is, closer to the inner circumference of the impeller 10, than is the outer circumferential second arc portion 234b. The outer circumferential second arc portion 234b is located closer to the corresponding one of the side plates 13, that is, closer to the outer circumference of the impeller 10, than is the outer circumferential first arc portion 234a.

The outer circumferential first arc portion 234a and the outer circumferential second arc portion 234b are arc-shaped portions when the outer circumferential first arc portion 234a and the outer circumferential second arc portion 234b are viewed in the axial direction of the rotation axis RA. The outer circumferential first arc portion 234a is formed and curves out in a direction opposite to the direction of rotation R of the blade 12 and formed open in the direction of rotation R when the outer circumferential first arc portion 234a is viewed in the axial direction of the rotation axis RA. The outer circumferential second arc portion 234b is formed and curves out in the direction of rotation R of the blade 12 and formed open in a direction opposite to the direction of rotation R of the blade 12 when the outer circumferential second arc portion 234b is viewed in the axial direction of the rotation axis RA.

The second vane portion 24 includes an inner circumferential first arc portion 244. The inner circumferential first arc portion 244 is an arc-shaped portion when the inner circumferential first arc portion 244 is viewed in the axial direction of the rotation axis RA. The inner circumferential first arc portion 244 is formed and curves out in a direction opposite to the direction of rotation R of the blade 12 and formed open in the direction of rotation R when the inner circumferential first arc portion 244 is viewed in the axial direction of the rotation axis RA.

The radius of curvature of the outer circumferential first arc portion 234a is here defined as a radius of curvature r1. The radius of curvature of the outer circumferential second arc portion 234b is also defined as a radius of curvature r2. The radius of curvature of the inner circumferential first arc portion 244 is also defined as a radius of curvature R. The blade 12 of the fourth example is formed to satisfy the relational expression “Radius of Curvature R>Radius of Curvature r1>Radius of Curvature r2”. Alternatively, the blade 12 of the fourth example is formed to satisfy the relational expression “Radius of Curvature r1>Radius of Curvature R>Radius of Curvature r2”.

That is, the blade 12 of the fourth example is formed such that the radius of curvature of the outer circumferential first arc portion 234a is larger than the radius of curvature of the outer circumferential second arc portion 234b. Further, the blade 12 of the fourth example is formed such that the radius of curvature of the inner circumferential first arc portion 244 is larger than the radius of curvature of the outer circumferential second arc portion 234b. The blade 12 of the fourth example is formed such that in a case in which the radii of curvature of the arc-shaped portions are compared, the radius of curvature of the outermost circumferential arc-shaped portion is smallest.

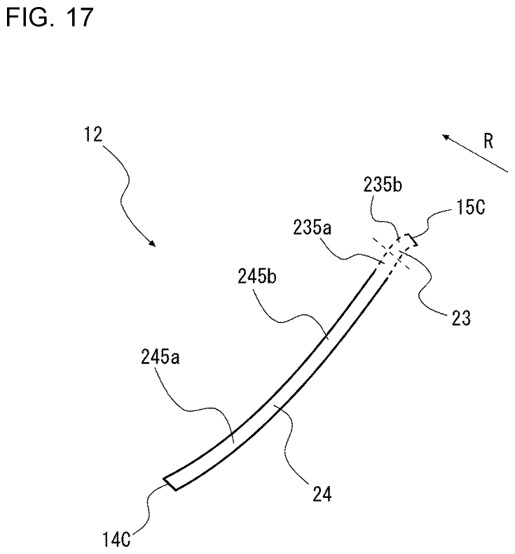

FIG. 17 is an enlarged view conceptually showing a fifth example of a blade 12 of the centrifugal air-sending device 100 according to Embodiment 1. The blade 12 of the fifth example is described with reference to FIG. 17. It should be noted that components that are identical in configuration to those of FIG. 13 are given identical reference signs and a description of such components is omitted. The first vane portion 23 includes an outer circumferential first arc portion 235a and an outer circumferential second arc portion 235b. The outer circumferential first arc portion 235a is located closer to the rotation axis RA, that is, closer to the inner circumference of the impeller 10, than is the outer circumferential second arc portion 235b. The outer circumferential second arc portion 235b is located closer to the corresponding one of the side plates 13, that is, closer to the outer circumference of the impeller 10, than is the outer circumferential first arc portion 235a.

The outer circumferential first arc portion 235a and the outer circumferential second arc portion 235b are arc-shaped portions when the outer circumferential first arc portion 235a and the outer circumferential second arc portion 235b are viewed in the axial direction of the rotation axis RA. The outer circumferential first arc portion 235a is formed and curves out in a direction opposite to the direction of rotation R of the blade 12 and formed open in the direction of rotation R when the outer circumferential first arc portion 235a is viewed in the axial direction of the rotation axis RA. The outer circumferential second arc portion 235b is formed and curves out in the direction of rotation R of the blade 12 and formed open in a direction opposite to the direction of rotation R of the blade 12 when the outer circumferential second arc portion 235b is viewed in the axial direction of the rotation axis RA.

The second vane portion 24 includes an inner circumferential first arc portion 245a and an inner circumferential second arc portion 245b. The inner circumferential first arc portion 245a is located closer to the rotation axis RA, that is, closer to the inner circumference of the impeller 10, than is the inner circumferential second arc portion 245b. The inner circumferential second arc portion 245b is located closer to the corresponding one of the side plates 13, that is, closer to the outer circumference of the impeller 10, than is the inner circumferential first arc portion 245a.

The inner circumferential first arc portion 245a and the inner circumferential second arc portion 245b are arc-shaped portions when the inner circumferential first arc portion 245a and the inner circumferential second arc portion 245b are viewed in the axial direction of the rotation axis RA. The inner circumferential first arc portion 245a and the inner circumferential second arc portion 245b are formed and curve out in a direction opposite to the direction of rotation R of the blade 12 and formed open in the direction of rotation R when the inner circumferential first arc portion 245a and the inner circumferential second arc portion 245b are viewed in the axial direction of the rotation axis RA.

The radius of curvature of the outer circumferential first arc portion 235a is here defined as a radius of curvature r1. The radius of curvature of the outer circumferential second arc portion 235b is also defined as a radius of curvature r2. The radius of curvature of the inner circumferential first arc portion 245a is also defined as a radius of curvature R1. The radius of curvature of the inner circumferential second arc portion 245b is also defined as a radius of curvature R2. The blade 12 of the fifth example is formed to satisfy the relational expression “Radius of Curvature R2>Radius of Curvature r1>Radius of Curvature R1>Radius of Curvature r2”. Alternatively, the blade 12 of the fifth example is formed to satisfy the relational expression “Radius of Curvature r1>Radius of Curvature R2>Radius of Curvature R1>Radius of Curvature r2”

That is, the blade 12 of the fifth example is formed such that the radius of curvature of the outer circumferential first arc portion 235a, the radius of curvature of the inner circumferential first arc portion 245a, or the radius of curvature of the inner circumferential second arc portion 245b is larger than the radius of curvature of the outer circumferential second arc portion 235b. Further, the blade 12 of the fifth example is formed such that the radius of curvature of the outer circumferential first arc portion 235a or the radius of curvature of the inner circumferential second arc portion 245b is larger than the radius of curvature of the inner circumferential first arc portion 245a. The blade 12 of the fifth example is formed such that in a case in which the radii of curvature of the arc-shaped portions are compared, the radius of curvature of the outermost circumferential arc-shaped portion is smallest. The blade 12 of the fifth example is formed such that in a case in which the radii of curvature of the arc-shaped portions are compared and the outer circumferential second arc portion 235b is excluded, the radius of curvature of the innermost circumferential arc-shaped portion is smallest.

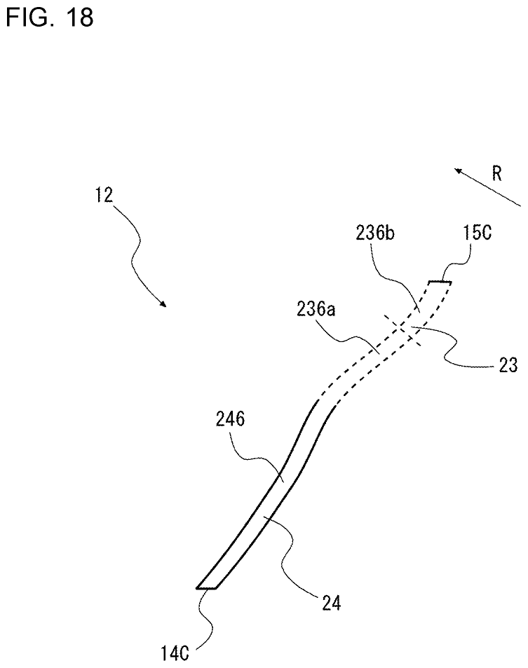

FIG. 18 is an enlarged view conceptually showing a sixth example of a blade 12 of the centrifugal air-sending device 100 according to Embodiment 1. The blade 12 of the sixth example is described with reference to FIG. 18. It should be noted that components that are identical in configuration to those of FIG. 13 are given identical reference signs and a description of such components is omitted. The first vane portion 23 includes an outer circumferential first arc portion 236a and an outer circumferential second arc portion 236b. The outer circumferential first arc portion 236a is located closer to the rotation axis RA, that is, closer to the inner circumference of the impeller 10, than is the outer circumferential second arc portion 236b. The outer circumferential second arc portion 236b is located closer to the corresponding one of the side plates 13, that is, closer to the outer circumference of the impeller 10, than is the outer circumferential first arc portion 236a.

The outer circumferential first arc portion 236a and the outer circumferential second arc portion 236b are arc-shaped portions when the outer circumferential first arc portion 236a and the outer circumferential second arc portion 236b are viewed in the axial direction of the rotation axis RA. The outer circumferential first arc portion 236a and the outer circumferential second arc portion 236b are formed and curve out in a direction opposite to the direction of rotation R of the blade 12 and formed open in the direction of rotation R when the outer circumferential first arc portion 236a and the outer circumferential second arc portion 236b are viewed in the axial direction of the rotation axis RA.

The second vane portion 24 includes an inner circumferential first arc portion 246. The inner circumferential first arc portion 246 is an arc-shaped portion when the inner circumferential first arc portion 246 is viewed in the axial direction of the rotation axis RA. The inner circumferential first arc portion 246 is formed and curves out in a direction opposite to the direction of rotation R of the blade 12 and formed open in the direction of rotation R when the inner circumferential first arc portion 246 is viewed in the axial direction of the rotation axis RA.

The radius of curvature of the outer circumferential first arc portion 236a is here defined as a radius of curvature r1. The radius of curvature of the outer circumferential second arc portion 236b is also defined as a radius of curvature r2. The radius of curvature of the inner circumferential first arc portion 246 is also defined as a radius of curvature R. The blade 12 of the sixth example is formed to satisfy the relational expression “Radius of Curvature R>Radius of Curvature r1>Radius of Curvature r2”. Alternatively, the blade 12 of the sixth example is formed to satisfy the relational expression “Radius of Curvature r2>Radius of Curvature R>Radius of Curvature r1”.

That is, the blade 12 of the sixth example is formed such that the radius of curvature of the inner circumferential first arc portion 246 is larger than the radius of curvature of the outer circumferential first arc portion 236a.

As shown in FIGS. 13 to 18, part of the first vane portion 23 is bent and thus includes at least one arc-shaped portion when the part of the first vane portion 23 is viewed in the axial direction of the rotation axis RA. It should be noted that the arc-shaped portion of the first vane portion 23 is formed integrally with the corresponding one of the side plate 13 by being connected to an inner circumferential end of the corresponding side plate 13. Further, as shown in FIGS. 14 to 18, part of the second vane portion 24 is bent and thus includes at least one arc-shaped portion when the part of the second vane portion 24 is viewed in the axial direction of the rotation axis RA.

### (Outlet Angle)

Next, outlet angles of the blades 12 are described with reference to FIG. 11. As shown in FIG. 11, an outlet angle of the first outer circumferential vane portion 12A1 of each of the first blades 12A in the first cross-section is defined as an outlet angle α1. That is, in the first cross-section, an outlet angle of a first vane portion 23 that corresponds to the first outer circumferential vane portion 12A1 is defined as an outlet angle α1. The outlet angle α1 is defined as an angle, at an intersection of a circular arc of the circle C3 centered around the rotation axis RA and the outer circumferential end 15A, formed by a tangent line TL1 to the circle C3 and a center line CL1 of the first vane portion 23 at the outer circumferential end 15A. This outlet angle α1 is formed at 90 degrees or less. The outlet angle α1 is an angle formed with the center line CL1 of the first vane portion 23 in a direction opposite to the direction of rotation in the circumferential direction CD.

An outlet angle of the second outer circumferential vane portion 12B1 of each of the second blades 12B in the same cross-section is defined as an outlet angle α2. That is, in the first cross-section, an outlet angle of a first vane portion 23 that corresponds to the second outer circumferential vane portion 12B1 is defined as an outlet angle α2. The outlet angle α2 is defined as an angle, at an intersection of a circular arc of the circle C3 centered around the rotation axis RA and the outer circumferential end 15B, formed by a tangent line TL2 to the circle C3 and a center line CL2 of the first vane portion 23 at the outer circumferential end 15B. The outlet angle α2 is formed at 90 degrees or less. The outlet angle α2 is an angle formed with the center line CL2 of the first vane portion 23 in the direction opposite to the direction of rotation in the circumferential direction CD.

The outlet angle α2 of the second outer circumferential vane portion 12B1 is equal to the outlet angle α1 of the first outer circumferential vane portion 12A1 (Outlet Angle α2=Outlet Angle α1). That is, the outlet angle α1 of the first vane portion 23 is formed at 90 degrees or less. It should be noted that the plurality of blades 12 are not limited to being formed such that the outlet angle α2 of the second outer circumferential vane portion 12B1 is equal to the outlet angle α1 of the first outer circumferential vane portion 12A1. The plurality of blades 12 need only be formed such that the outlet angle α2 and the outlet angle α1 are each formed at 90 degrees or less, and the outlet angle α2 may be different from the outlet angle α1. The first vane portions 23, which correspond to the first outer circumferential vane portion 12A1 and the second outer circumferential vane portion 12B1, are formed in arcs and curve out in a direction opposite to the direction of rotation R when viewed from an angle parallel with the rotation axis RA.

Although not illustrated, the impeller 10 is formed such that in the second cross-section shown in FIG. 2 too, the outlet angle α1 of the first outer circumferential vane portion 12A1 and the outlet angle α2 of the second outer circumferential vane portion 12B1 are equal to each other. That is, each of the plurality of blades 12 has a first vane portion 23 extending from the main plate 11 to the side plate 13 and having an outlet angle of 90 degrees or less.

Further, as shown in FIG. 10, an outlet angle of the first inner circumferential vane portion 12A2 of each of the first blades 12A in the first cross-section is defined as an outlet angle β1. The outlet angle β1 is defined as an angle, at an intersection of a circular arc of a circle C4 centered around the rotation axis RA and the first inner circumferential vane portion 12A2, formed by a tangent line TL3 to the circle C4 and a center line CL3 of the first inner circumferential vane portion 12A2. This outlet angle β1 is an angle of smaller than 90 degrees. The outlet angle β1 is an angle formed with the center line CL3 of the second vane portion 24 in the direction opposite to the direction of rotation in the circumferential direction CD.

An outlet angle of the second inner circumferential vane portion 12B2 of each of the second blades 12B in the same cross-section is defined as an outlet angle β2. The outlet angle β2 is defined as an angle, at an intersection of a circular arc of the circle C4 centered around the rotation axis RA and the second inner circumferential vane portion 12B2, formed by a tangent line TL4 to the circle C4 and a center line CL4 of the second inner circumferential vane portion 12B2. The outlet angle β2 is an angle of smaller than 90 degrees. The outlet angle β2 is an angle formed with the center line CL3 of the second vane portion 24 in the direction opposite to the direction of rotation in the circumferential direction CD. Although not illustrated in FIG. 12, the impeller 10 is formed such that in the second cross-section too, the outlet angle β1 and the outlet angle β2 are angles of smaller than 90 degrees.

### (Inlet Angle)

Further, as shown in FIG. 11, an inlet angle of the first inner circumferential vane portion 12A2 of each of the first blades 12A in the first cross-section is defined as an inlet angle γ1. The inlet angle γ1 is defined as an angle, at an intersection of a circular arc of the circle C1 centered around the rotation axis RA and the first inner circumferential vane portion 12A2, formed by a tangent line TL5 to the circle C1 and a center line CL5 of the first inner circumferential vane portion 12A2. That is, a portion of the blade 12 that forms the inlet angle γ1 is a second vane portion 24. This inlet angle γ1 is an angle of smaller than 90 degrees. The inlet angle γ1 is an angle formed with the center line CL5 of the second vane portion 24 in the direction opposite to the direction of rotation in the circumferential direction CD.

An inlet angle of the second inner circumferential vane portion 12B2 of each of the second blades 12B in the same cross-section is defined as an inlet angle γ2. The inlet angle γ2 is defined as an angle, at an intersection of a circular arc of the circle C2 centered around the rotation axis RA and the second inner circumferential vane portion 12B2, formed by a tangent line TL6 to the circle C2 and a center line CL6 of the second inner circumferential vane portion 12B2. That is, a portion of the blade 12 that forms the inlet angle γ2 is a second vane portion 24. The inlet angle γ2 is an angle of smaller than 90 degrees. The inlet angle γ2 is an angle formed with the center line CL6 of the second vane portion 24 in the direction opposite to the direction of rotation in the circumferential direction CD. Although not illustrated in FIG. 12, the impeller 10 is formed such that in the second cross-section too, the inlet angle γ1 and the inlet angle γ2 are angles of smaller than 90 degrees.

### (Inter-vane Distance)

When a spacing between two of the plurality of blades 12 adjacent to each other in the circumferential direction CD is defined as an inter-vane distance, the inter-vane distance between a plurality of blades 12 widens from the leading edges 14A1 toward the trailing edges 15A1 as shown in FIGS. 10 and 12. Similarly, the inter-vane distance between a plurality of blades 12 widens from the leading edges 14B1 toward the trailing edges 15B1.

Specifically, the inter-vane distance between inner circumferential vane portions corresponding to a first inner circumferential vane portion 12A2 and a second inner circumferential vane portion 12B2 widens from the inner circumference toward the outer circumference. That is, the impeller 10 is formed such that the inter-vane distance between the inner circumferential vane portions widens from the inner circumference toward the outer circumference. Further, the inter-vane distance between outer circumferential vane portions corresponding to a first outer circumferential vane portion 12A1 and a second outer circumferential vane portion 12B1 is wider than the inter-vane distance between the inner circumferential vane portions and widens from the inner circumference toward the outer circumference.

In other words, an inter-vane distance between a first inner circumferential vane portion 12A2 and a second inner circumferential vane portion 12B2 or an inter-vane distance between adjacent second inner circumferential vane portions 12B2 widens from the inner circumference toward the outer circumference. Further, the inter-vane distance between a first outer circumferential vane portion 12A1 and a second outer circumferential vane portion 12B1 or the inter-vane distance between adjacent second outer circumferential vane portions 12B1 is wider than the inter-vane distance between the inner circumferential vane portions and widens from the inner circumference toward the outer circumference.

(Relationship between Impeller 10 and Scroll Casing 40)

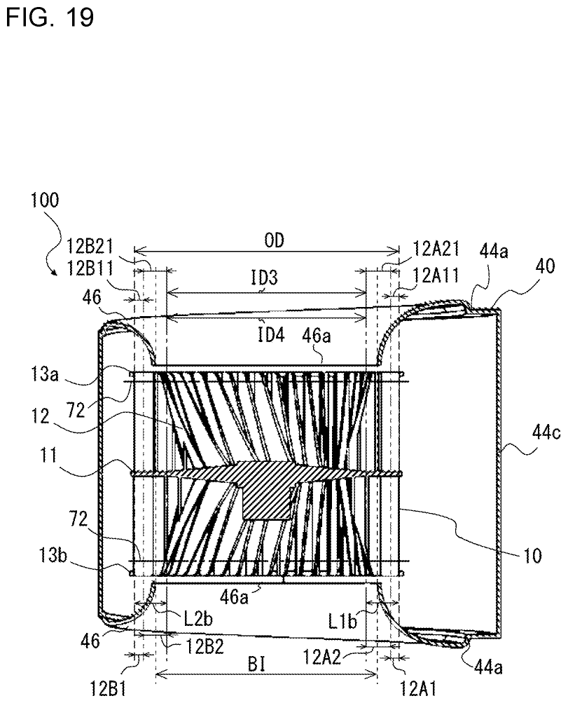

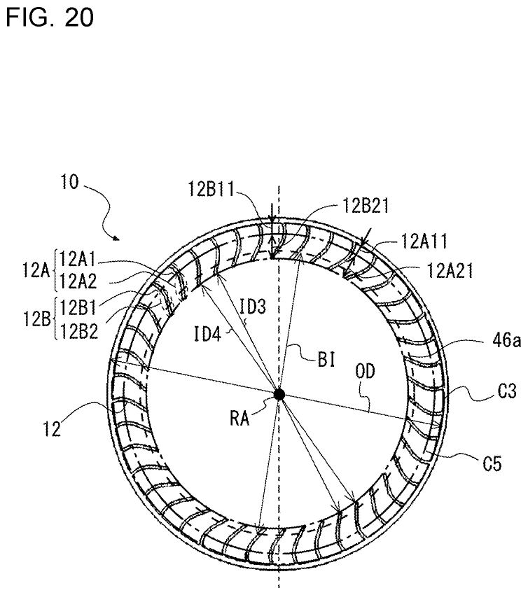

FIG. 19 is a schematic view showing a relationship between the impeller 10 and the scroll casing 40 in the cross-section of the centrifugal air-sending device 100 as taken along line A-A in FIG. 2. FIG. 20 is a schematic view showing a relationship between blades 12 and the bell mouth 46 as viewed from an angle parallel with the rotation axis RA in the impeller 10 shown in FIG. 19. It should be noted that FIG. 20 shows blades 12 beside one of the side plates 13.

As shown in FIGS. 19 and 20, a blade outside diameter OD defined by the outer circumferential ends of the plurality of blades 12 is larger than an inside diameter BI of the bell mouth 46 of the scroll casing 40. It should be noted that the blade outside diameter OD of the plurality of blades 12 is equal to each of the outside diameters OD1 and OD2 of the first blades 12A shown in FIG. 10 and each of the outside diameters OD3 and OD4 of the second blades 12B shown in FIG. 12 (Blade Outside Diameter OD=Outside Diameter OD1=Outside Diameter OD2=Outside Diameter OD3=Outside Diameter OD4).

The impeller 10 has, in radial directions from the rotation axis RA, a portion in which the first inner circumferential region 12A21 is larger than the first outer circumferential region 12A11. That is, the impeller 10 and each of the first blades 12A include, in a radial direction from the rotation axis RA, a portion in which a ratio of the first inner circumferential vane portion 12A2 is larger than a ratio of the first outer circumferential vane portion 12A1 and that has the relationship “First Outer Circumferential Vane Portion 12A1<First Inner Circumferential Vane Portion 12A2”. The relationship between the ratio of the first outer circumferential vane portion 12A1 and the ratio of the first inner circumferential vane portion 12A2 in the radial direction of the rotation axis RA may hold in both the main-plate-side blade region 122a serving as the first region and the side-plate-side blade region 122b serving as the second region.

It should be noted that the impeller 10 and each of the first blades 12A are not limited to being formed such that in a radial direction from the rotation axis RA, a ratio of the first inner circumferential vane portion 12A2 is larger than a ratio of the first outer circumferential vane portion 12A1. The impeller 10 and each of the first blades 12A may be formed such that in a radial direction from the rotation axis RA, a ratio of the first inner circumferential vane portion 12A2 is smaller than or equal to a ratio of the first outer circumferential vane portion 12A1.

Similarly, the impeller 10 has, in the radial directions from the rotation axis RA, a portion in which the second inner circumferential region 12B21 is larger than the second outer circumferential region 12B11. That is, the impeller 10 and each of the second blades 12B include, in a radial direction from the rotation axis RA, a portion in which a ratio of the second inner circumferential vane portion 12B2 is larger than a ratio of the second outer circumferential vane portion 12B1 and that has the relationship “Second Outer Circumferential Vane Portion 12B1<Second Inner Circumferential Vane Portion 12B2”. The relationship between the ratio of the second outer circumferential vane portion 12B1 and the ratio of the second inner circumferential vane portion 12B2 in the radial direction of the rotation axis RA may hold in both the main-plate-side blade region 122a serving as the first region and the side-plate-side blade region 122b serving as the second region.

It should be noted that the impeller 10 and each of the second blades 12B are not limited to being formed such that in a radial direction from the rotation axis RA, a ratio of the second inner circumferential vane portion 12B2 is larger than a ratio of the second outer circumferential vane portion 12B1. The impeller 10 and each of the second blades 12B may be formed such that in a radial direction from the rotation axis RA, a ratio of the second inner circumferential vane portion 12B2 is smaller than or equal to a ratio of the second outer circumferential vane portion 12B1.

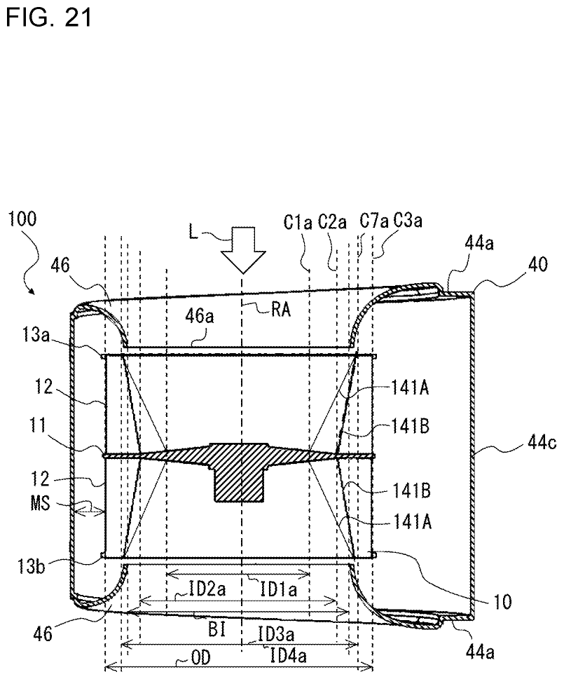

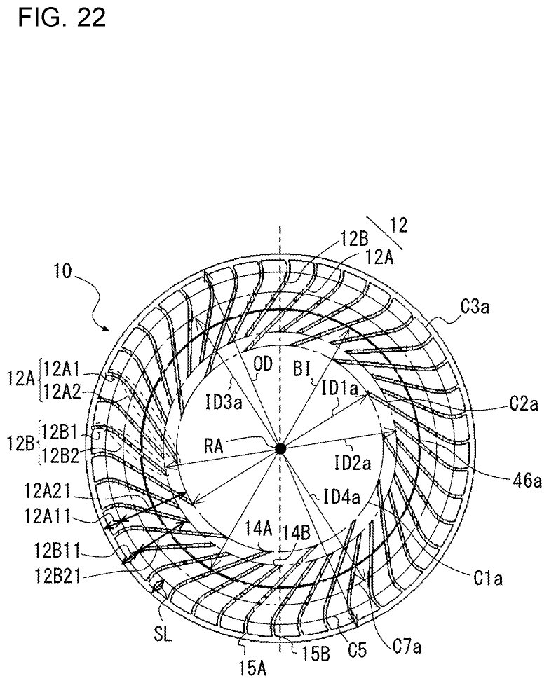

FIG. 21 is a schematic view showing a relationship between the impeller 10 and the scroll casing 40 in the cross-section of the centrifugal air-sending device 100 as taken along line A-A in FIG. 2. FIG. 22 is a schematic view showing a relationship between blades 12 and the bell mouth 46 as viewed from an angle parallel with the rotation axis RA in the impeller 10 shown in FIG. 21. In FIG. 21, the arrow outline L indicates a direction from which the impeller 10 is viewed from an angle parallel with the rotation axis RA.

As shown in FIGS. 21 and 22, a circle passing through the inner circumferential ends 14A of the plurality of first blades 12A around the rotation axis RA at connecting locations between the first blades 12A and the main plate 11 when viewed from an angle parallel with the rotation axis RA is defined as a circle C1a. Moreover, the diameter of the circle C1a, that is, the inside diameter of the first blades 12A at the connecting locations between the first blades 12A and the main plate 11, is defined as an inside diameter ID1a.

Further, a circle passing through the inner circumferential ends 14B of the plurality of second blades 12B around the rotation axis RA at connecting locations between the second blades 12B and the main plate 11 when viewed from an angle parallel with the rotation axis RA is defined as a circle C2a. Moreover, the diameter of the circle C2a, that is, the inside diameter of the second blades 12B at the connecting locations between the first blades 12A and the main plate 11, is defined as an inside diameter ID2a. The inside diameter ID2a is larger than the inside diameter ID1a

### (Inside Diameter ID2a>Inside Diameter ID1a).

Further, the diameter of a circle C3a passing through the outer circumferential ends 15A of the plurality of first blades 12A and the outer circumferential ends 15B of the plurality of second blades 12B around the rotation axis RA when viewed from an angle parallel with the rotation axis RA, that is, the outside diameter of the plurality of blades 12, is defined as the blade outside diameter OD.

Further, a circle passing through the inner circumferential ends 14A of the plurality of first blades 12A around the rotation axis RA at connecting locations between the first blades 12A and each of the side plates 13 when viewed from an angle parallel with the rotation axis RA is defined as a circle C7a. Moreover, the diameter of the circle C7a, that is, the inside diameter of the first blades 12A at the connecting locations between the first blades 12A and each of the side plates 13, is defined as an inside diameter ID3a.

Further, a circle passing through the inner circumferential ends 14B of the plurality of second blades 12B around the rotation axis RA at connecting locations between the second blades 12B and each of the side plates 13 when viewed from an angle parallel with the rotation axis RA is the circle C7a. Moreover, the diameter of the circle C7a, that is, the inside diameter of the second blades 12B at the connecting locations between the second blades 12B and each of the side plates 13, is defined as an inside diameter ID4a.

As shown in FIGS. 21 and 22, the inside diameter BI of the bell mouth 46 is located in a region of the first inner circumferential vane portions 12A2 and the second inner circumferential vane portions 12B2 between the inside diameter ID1a of the first blades 12A beside the main plate 11 and the inside diameter ID3a of the first blades 12A beside each of the side plates 13 when viewed from an angle parallel with the rotation axis RA. More specifically, the inside diameter BI of the bell mouth 46 is larger than the inside diameter ID1a of the first blades 12A beside the main plate 11 and smaller than the inside diameter ID3a of the first blades 12A beside each of the side plates 13.

That is, the inside diameter BI of the bell mouth 46 is formed to be larger than the blade inside diameter of the plurality of blades 12 beside the main plate 11 and smaller than the blade inside diameter of the plurality of blades 12 beside each of the side plates 13. In other words, an inner circumferential edge portion 46a forming the inside diameter BI of the bell mouth 46 is located in a region of the first inner circumferential vane portions 12A2 and the second inner circumferential vane portions 12B2 between the circle C1a and the circle C7a when viewed from an angle parallel with the rotation axis RA.

Further, as shown in FIGS. 21 and 22, the inside diameter BI of the bell mouth 46 is located in a region of the first inner circumferential vane portions 12A2 and the second inner circumferential vane portions 12B2 between the inside diameter ID2a of the second blades 12B beside the main plate 11 and the inside diameter ID4a of the second blades 12B beside each of the side plates 13 when viewed from an angle parallel with the rotation axis RA. More specifically, the inside diameter BI of the bell mouth 46 is larger than the inside diameter ID2a of the second blades 12B beside the main plate 11 and smaller than the inside diameter ID4a of the second blades 12B beside each of the side plates 13.

That is, the inside diameter BI of the bell mouth 46 is formed to be larger than the blade inside diameter of the plurality of blades 12 beside the main plate 11 and smaller than the blade inside diameter of the plurality of blades 12 beside each of the side plates 13. More specifically, the inside diameter BI of the bell mouth 46 is formed to be larger than a blade inside diameter defined by the inner circumferential ends of the plurality of blades 12 in the first region and smaller than a blade inside diameter defined by the inner circumferential ends of the plurality of blades 12 in the second region. The inner circumferential edge portion 46a forming the inside diameter BI of the bell mouth 46 is located in a region of the first inner circumferential vane portions 12A2 and the second inner circumferential vane portions 12B2 between the circle C2a and the circle C7a when viewed from an angle parallel with the rotation axis RA.

As shown in FIGS. 21 and 22, in the radial direction of the impeller 10, a radial length of each of the first and second outer circumferential vane portions 12A1 and 12B1 is defined as a distance SL. Further, in the centrifugal air-sending device 100, the shortest distance between the plurality of blades 12 of the impeller 10 and the circumferential wall 44c of the scroll casing 40 is defined as a distance MS. In this case, the centrifugal air-sending device 100 is formed such that the distance MS is more than twice as long as the distance SL (Distance MS>Distance SL×2). Although the distance MS is shown in the A-A section of the centrifugal air-sending device 100 in FIG. 21, the distance MS is the shortest distance from the circumferential wall 44c of the scroll casing 40 and is not necessarily shown on the A-A section.

### (Configuration of Outer Circumferential Blade Portion 26)

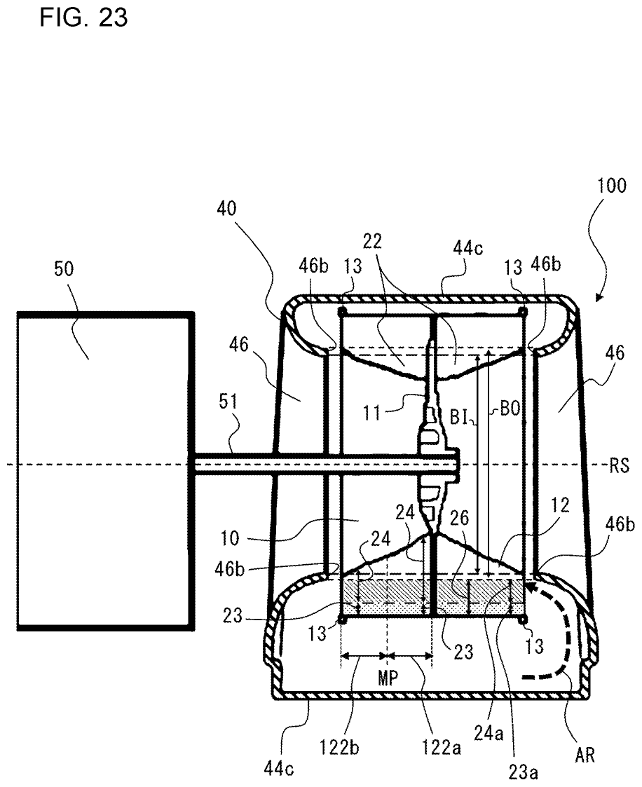

FIG. 23 is a schematic view showing a relationship between the impeller 10 and the bell mouth 46 in the cross-section of the centrifugal air-sending device 100 as taken along line A-A in FIG. 2. As shown in FIG. 23, the blades 12 include inner blade portions 22 that protrude further inward than an inner circumferential end portion 46b of the bell mouth 46 in radial directions starting from the rotation axis RA as a radial center. The inner blade portions 22 are portions of the plurality of blades 12 located in the region of formation of the inside diameter BI of the bell mouth 46.

Each of the plurality of blades 12 is formed such that the vane length of the blade 12 in a first region close to the main plate 11 is longer than the vane length of the blade 12 in a second region close to each of the side plates 13. Further, each of the plurality of blades 12 has a portion of the vane length of the blade 12 in a radial direction in which a ratio of the second vane portion 24 in the radial direction is larger than a ratio of the first vane portion 23 in the radial direction. As mentioned above, the first region is the main-plate-side blade region 122a, and the second region is the side-plate-side blade region 122b.

In radial directions, portions of the plurality of blades 12 located further outward than is the outside diameter BO of the inner circumferential end portion 46b of the bell mouth 46 are defined as outer circumferential blade portions 26. Each of the plurality of blades 12 includes an outer circumferential blade portion 26 that forms a portion located closer to the outer circumference than is the inner circumferential end portion 46b, which is an end portion of an inner circumference of the bell mouth 46 in a radial direction.

The outer circumferential blade portion 26 is formed such that in both the first region and the second region, a ratio of the second vane portion 24 in the length of the blade 12 in a radial direction is larger than a ratio of the first vane portion 23 in the length of the blade 12 in the radial direction (Ratio of Second Vane Portion 24>Ratio of First Vane Portion 23). That is, the centrifugal air-sending device 100 is formed such that in the length of the blade 12 in a radial direction, a ratio of an outer second vane portion 24a located further outward than is the outside diameter of the inner circumferential end portion 46b of the bell mouth 46 is larger than a ratio of an outer first vane portion 23a.

In FIG. 23, the first vane portion 23 is a generic name for the first outer circumferential vane portion 12A1 and the second outer circumferential vane portion 12B1, and the second vane portion 24 is a generic name for the first inner circumferential vane portion 12A2 and the second inner circumferential vane portion 12B2. Moreover, in FIG. 23, the outer first vane portion 23a is a generic name for a first outer circumferential vane portion 12A1 and a second outer circumferential vane portion 12B1 that are located closer to the outer circumference than is the inner circumferential end portion 46b of the bell mouth 46 when viewed from an angle parallel with the rotation axis RA. Further, the outer second vane portion 24a is a generic name for a first inner circumferential vane portion 12A2 and a second inner circumferential vane portion 12B2 that are located closer to the outer circumference than is the inner circumferential end portion 46b of the bell mouth 46 when viewed from an angle parallel with the rotation axis RA.

### [Operation of Centrifugal Air-sending Device 100]

Operation of the centrifugal air-sending device is described with reference to FIG. 23. The centrifugal air-sending device 100 is configured such that once the motor 50 is brought into operation, the plurality of blades 12 rotate around the rotation axis RA via the motor shaft 51 and the main plate 11. This allows the centrifugal air-sending device 100 to cause air outside the scroll casing 40 to be sucked into the impeller 10 through the case air inlets 45, and the pressure-raising action of the impeller 10 causes the air to be blown out from the impeller 10 into the scroll casing 40. The air blown out from the impeller 10 into the scroll casing 40 recovers its static pressure by having its speed reduced through an expanded air trunk defined by the circumferential wall 44c of the scroll casing 40, and is blown out through the discharge port 42a shown in FIG. 1.

### [Working Effects of Centrifugal Air-sending Device 100]

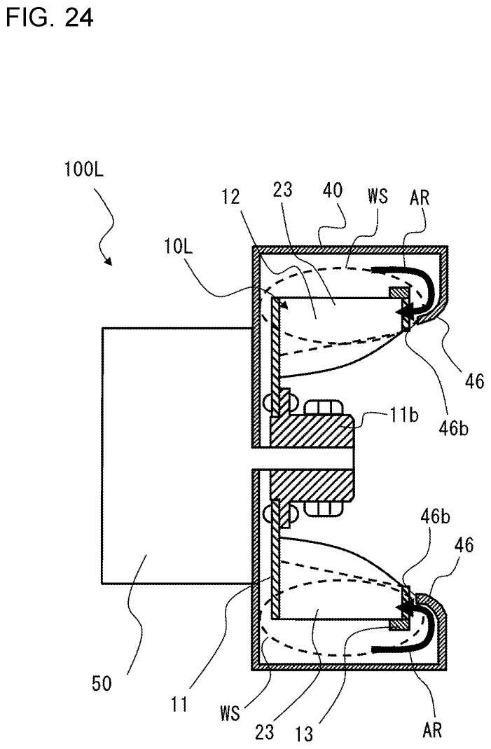

FIG. 24 is a cross-sectional view of a centrifugal air-sending device 100L according to a comparative example. In the centrifugal air-sending device 100L according to the comparative example, a portion of a blade 12 located further outward than is the inner circumferential end portion 46b of the bell mouth 46 indicated by a range WS is only a portion that forms a first vane portion 23. Therefore, when a current of air AR flows again into an impeller 10L, the current of air AR blown out from the impeller 10L and flowing along the inner wall surface of the bell mouth 46 collides with a portion of the first vane portion 23 in which an outlet angle is large and the inflow velocity of the current of air increases. Therefore, the current of air AR colliding with the first vane portion 23 causes noise from the centrifugal air-sending device 100L and also causes input deterioration.

On the other hand, the centrifugal air-sending device 100 according to Embodiment 1 is configured such that each of the plurality of blades 12 includes a first vane portion 23 that includes the outer circumferential end 15A or the outer circumferential end 15B and is formed such that an outlet angle α1 or α2 is formed at 90 degrees or less. As the outlet angle is formed at 90 degrees or less, the centrifugal air-sending device 100 raises a static pressure when the operating range is in a high pressure loss state and, by including multiple blades, increases an air volume. As a result, by decreasing the outlet angle when the current of air flowing along the inner wall surface of the bell mouth 46 flows again into the impeller 10, the centrifugal air-sending device 100 reduces a loss caused by a collision with the current of air, thereby reducing noise caused by the current of air and reducing input deterioration.

Further, the first vane portion 23 and the second vane portion 24 are each bent and thus include at least one arc-shaped portion when the first vane portion 23 and the second vane portion 24 are viewed in the axial direction of the rotation axis RA, and the first vane portion 23 and the second vane portion 24 are formed such that a radius of curvature of the first vane portion 23 is smaller than a radius of curvature of the second vane portion 24. In a case in which there is only one arc-shaped portion in a vane portion formed by a combination of the first vane portion 23 and the second vane portion 24, there is a possibility that a current of air flowing into the vane portion may separate from the vane portion. By having the foregoing configuration, the centrifugal air-sending device 100 causes an inflow current of air to flow along a vane surface without separating from the vane portion, thus making it possible to increase air-sending efficiency. That is, by having a plurality of arc-shaped portions in a vane portion formed by a combination of the first vane portion 23 and the second vane portion 24, the centrifugal air-sending device 100 causes an inflow current of air to flow along a vane surface without separating from the vane portion, thus making it possible to increase air-sending efficiency.

Further, in the centrifugal air-sending device 100, the first vane portion 23 may be bent and thus include at least one arc-shaped portion when the first vane portion 23 is viewed in the axial direction of the rotation axis RA, and the second vane portion 24 may be linearly formed when the second vane portion 24 is viewed in the axial direction of the rotation axis RA. Linearly forming the second vane portion 24 makes it possible to easily manufacture the centrifugal air-sending device 100 and lower the cost of manufacturing the centrifugal air-sending device 100. Having the foregoing configuration makes it possible to easily manufacture the centrifugal air-sending device 100 and reduce the cost of manufacturing the centrifugal air-sending device 100 and makes it possible to cause an inflow current of air to flow along a vane surface without separating from the vane portion, thus making it possible to increase air-sending efficiency. In comparison with a centrifugal air-sending device 100 having a plurality of arc-shaped portions in a vane portion formed by a combination of the first vane portion 23 and the second vane portion 24, the centrifugal air-sending device 100 thus configured brings about almost the same effect of increasing air-sending efficiency.

Further, the outer circumferential blade portion 26 of the centrifugal air-sending device 100 is formed such that a ratio of the second vane portion 24 in a radial direction is larger than a ratio of the first vane portion 23 in the radial direction. Further, by having such a configuration, the centrifugal air-sending device 100 raises a static pressure when the operating range is in a low pressure loss state and, by including multiple blades, increases an air volume. Therefore, in the centrifugal air-sending device 100 thus configured, a current of air AR flowing again into the impeller 10 along the inner wall surface of the bell mouth 46 collides with the second vane portion 24, in which the inflow velocity of the current of air decreases. As a result, when the current of air flowing along the inner wall surface of the bell mouth 46 flows again into the impeller 10, the centrifugal air-sending device 100 reduces noise caused by the current of air and reduces input deterioration.

Further, each of the plurality of blades 12 is shaped such that the vane length continuously changes in size from the main plate 11 to the corresponding one of the side plates 13. By having such a configuration, the centrifugal air-sending device 100 reduces a pressure loss at the time of suction, as the vane length changes in size according to a state of suction of air.

Further, each of the plurality of blades 12 has a portion between the main plate 11 and the corresponding one of the side plates 13 in which the vane length is constant in size. In a case in which the vane length is elongated in the axial direction, it becomes hard to make molds for the vane portions of the centrifugal air-sending device. By having the foregoing configuration, the centrifugal air-sending device 100 makes, in a portion between the main plate 11 and each of the side plates 13, a place where there is no change in vane length and, by causing the place where there is no change in vane length to be a divided face of a mold, achieves a longer vane length than does a centrifugal air-sending device not having the foregoing configuration. This allows the centrifugal air-sending device 100 thus configured to increase an air volume in comparison with a centrifugal air-sending device not having the foregoing configuration.

### Embodiment 2

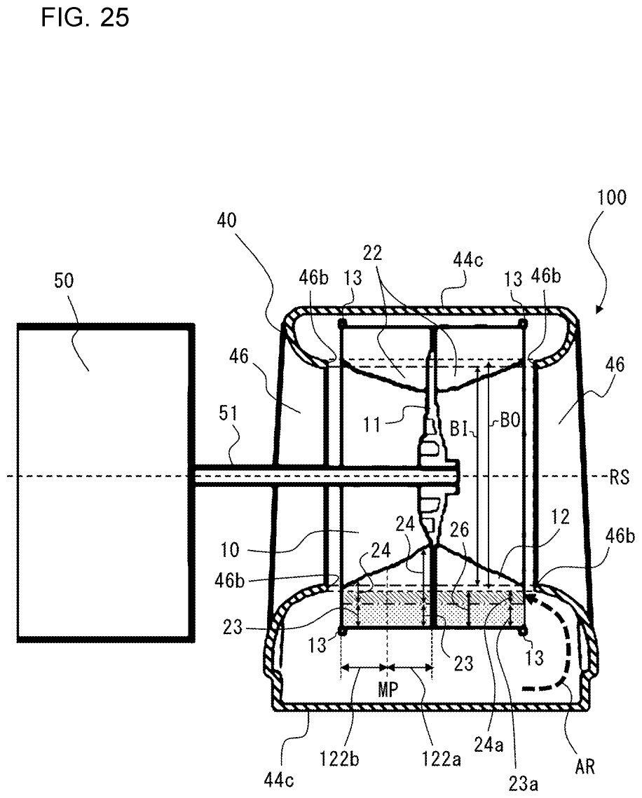

FIG. 25 is a cross-sectional view schematically showing a centrifugal air-sending device 100 according to Embodiment 2. It should be noted that components that are identical in configuration to those of the centrifugal air-sending device 100 or other devices of FIGS. 1 to 24 are given identical reference signs and a description of such components is omitted. The centrifugal air-sending device 100 according to Embodiment 2 is intended to illustrate another embodiment that specifies a relationship between the impeller 10 and the scroll casing 40 of the centrifugal air-sending device 100 according to Embodiment 1.

The outer circumferential blade portion 26 is formed such that in both the first region and the second region, a ratio of the second vane portion 24 in the length of the blade 12 in a radial direction is smaller than a ratio of the first vane portion 23 in the length of the blade 12 in the radial direction (Ratio of First Vane Portion 23>Ratio of Second Vane Portion 24). As shown in FIG. 25, the centrifugal air-sending device 100 is formed such that in the length of the blade 12 in a radial direction, a ratio of an outer second vane portion 24a located further outward than is the outside diameter of the inner circumferential end portion 46b of the bell mouth 46 is smaller than a ratio of an outer first vane portion 23a. That is, the centrifugal air-sending device 100 is formed such that in the length of the blade 12 in a radial direction, a ratio of an outer first vane portion 23a located further outward than is the outside diameter of the inner circumferential end portion 46b of the bell mouth 46 is larger than a ratio of an outer second vane portion 24a.

### [Working Effects of Centrifugal Air-sending Device 100]

Further, the outer circumferential blade portion 26 of the centrifugal air-sending device 100 according to Embodiment 2 is formed such that a ratio of the second vane portion 24 in the radial direction is smaller than a ratio of the first vane portion 23 in the radial direction. By having such a configuration, the centrifugal air-sending device 100 according to Embodiment 2 expands the operating range, as adjustment of the outlet angles α1 or α2 of the blades 12 does not depend on the inlet angles of the blades 12.

Further, by having a configuration similar to that of the centrifugal air-sending device 100 according to Embodiment 1, the centrifugal air-sending device 100 according to Embodiment 2 raises a static pressure when the operating range is in a high pressure loss state and, by including multiple blades, increases an air volume. As a result, by decreasing the outlet angle when the current of air flowing along the inner wall surface of the bell mouth 46 flows again into the impeller 10, the centrifugal air-sending device 100 reduces a loss caused by a collision with the current of air, thereby reducing noise caused by the current of air and reducing input deterioration.

Embodiments 1 and 2 have been described as an example in a case in which a centrifugal air-sending device 100 includes a double-suction impeller 10 having a plurality of blades 12 formed on both sides of a main plate 11. However, the centrifugal air-sending device 100 of Embodiment 1 or 2 is not limited to a centrifugal air-sending device 100 including a double-suction impeller 10. Alternatively, the centrifugal air-sending device 100 of Embodiment 1 or 2 is also applicable to a single-suction centrifugal air-sending device 100 including an impeller 10 having a plurality of blades 12 formed only on one side of a main plate 11 and a scroll casing 40 having a case air inlet 45 formed only on the one side of the main plate 11.

### Embodiment 3

### [Air-conditioning Apparatus 140]

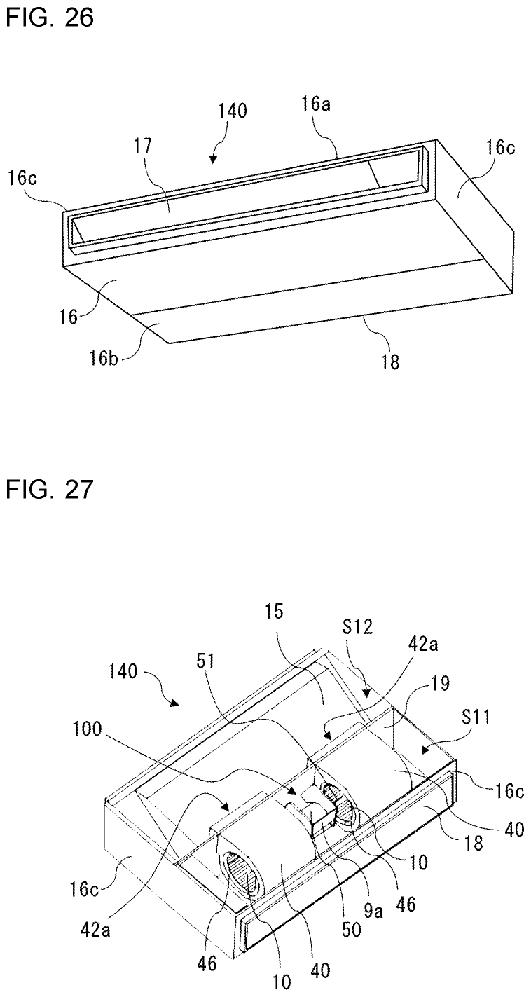

FIG. 26 is a perspective view of an air-conditioning apparatus 140 according to Embodiment 3. FIG. 27 is a diagram showing an internal configuration of the air-conditioning apparatus 140 according to Embodiment 3. As for a centrifugal air-sending device 100 that is used in the air-conditioning apparatus 140 according to Embodiment 3, components that are identical in configuration to those of the centrifugal air-sending device 100 or other devices of FIGS. 1 to 27 are given identical reference signs, and a description of such components is omitted. Further, FIG. 27 omits an upper surface portion 16a to show the internal configuration of the air-conditioning apparatus 140.

The air-conditioning apparatus 140 according to Embodiment 3 includes the centrifugal air-sending device 100 according to Embodiment 1 or 2 and a heat exchanger 15 disposed in a location at which the heat exchanger 15 faces a discharge port 42a of the centrifugal air-sending device 100. It should be noted that the air-conditioning apparatus 140 may include a plurality of centrifugal air-sending devices 100 instead of including a single centrifugal air-sending device 100. Further, the air-conditioning apparatus 140 according to Embodiment 3 includes a case 16 installed in a ceiling space of a room to be air-conditioned.

### (Case 16)

As shown in FIG. 26, the case 16 is formed in a cuboidal shape including the upper surface portion 16a, a lower surface portion 16b, and side surface portions 16c. The shape of the case 16 is not limited to the cuboidal shape and may for example be another shape such as a circular columnar shape, a prismatic shape, a conical shape, a shape having a plurality of corner portions, and a shape having a plurality of curved surface portions.

One of the side surface portions 16c of the case 16 is a side surface portion 16c in which a case discharge port 17 is formed. The case discharge port 17 is formed in a rectangular shape as shown in FIG. 26. The shape of the case discharge port 17 is not limited to the rectangular shape and may for example be another shape such as a circular shape and an oval shape.

Another one of the side surface portions 16c of the case 16 is a side surface portion 16c in which a case suction port 18 is formed and being opposite to the side surface portion 16c in which the case discharge port 17 is formed. The case suction port 18 is formed in a rectangular shape as shown in FIG. 27. The shape of the case suction port 18 is not limited to the rectangular shape and may for example be another shape such as a circular shape and an oval shape. A filter to remove dust in the air may be disposed at the case suction port 18.

Inside the case 16, the centrifugal air-sending device 100 and the heat exchanger 15 are housed. The centrifugal air-sending device 100 includes impellers 10, scroll casings 40 in which respective bell mouths 46 are formed, and a motor 50. The motor 50 is supported by a motor support 9a fixed to the upper surface portion 16a of the case 16. The motor 50 has a motor shaft 51. The motor shaft 51 is disposed to extend parallel to the side surface portion 16c in which the case suction port 18 is formed and the side surface portion 16c in which the case discharge port 17 is formed.

As shown in FIG. 27, the air-conditioning apparatus 140 has two impellers 10 attached to the motor shaft 51. The impellers 10 of the centrifugal air-sending device 100 form a flow of air that is sucked into the case 16 through the case suction port 18 and blown out into an air-conditioned space through the case discharge port 17. The number of impellers 10 that are disposed in the case 16 is not limited to two and may be one or larger than or equal to three.

As shown in FIG. 27, the centrifugal air-sending device 100 is attached to a divider 19, which divides an internal space of the case 16 into a space S11 in which air is sucked into the scroll casings 40 and a space S12 in which air is blown out from the scroll casings 40.

The heat exchanger 15 is disposed in a location at which the heat exchanger 15 faces the discharge ports 42a of the centrifugal air-sending device 100, and is disposed in the case 16 and on air trunks of air to be discharged by the centrifugal air-sending device 100. The heat exchanger 15 adjusts the temperature of air that is sucked into the case 16 through the case suction port 18 and blown out into the air-conditioned space through the case discharge port 17. As the heat exchanger 15, a heat exchanger of a publicly-known structure may be applied. The case suction port 18 need only be formed in a location perpendicular to the axial direction of the rotation axis RA of the centrifugal air-sending device 100. For example, the case suction port 18 may be formed in the lower surface portion 16b.

Rotation of the impeller 10 of the centrifugal air-sending device 100 causes the air in the air-conditioned space to be sucked into the case 16 through the case suction port 18. The air sucked into the case 16 is guided to the bell mouth 46 and sucked into the impeller 10. The air sucked into the impeller 10 is blown out outward in radial directions of the impeller 10. The air blown out from the impeller 10 passes through the inside of the scroll casing 40, is blown out through the discharge port 42a, and then is supplied to the heat exchanger 15. The air supplied to the heat exchanger 15 is subjected to temperature and humidity control by, during passage through the heat exchanger 15, exchanging heat with refrigerant flowing through the inside of the heat exchanger 15. The air having passed through the heat exchanger 15 is blown out to the air-conditioned space through the case discharge port 17.

The air-conditioning apparatus 140 according to Embodiment 3 includes the centrifugal air-sending device 100 according to Embodiment 1 or 2. Therefore, the air-conditioning apparatus 140 brings about effects similar to those of the centrifugal air-sending device 100 according to Embodiment 1 or 2.

### Embodiment 4

### [Refrigeration Cycle Apparatus 150]

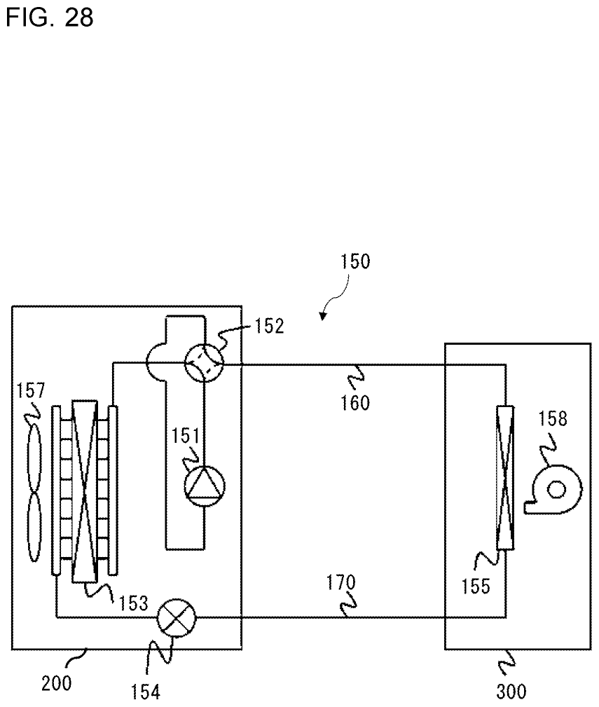

FIG. 28 is a diagram showing a configuration of a refrigeration cycle apparatus 150 according to Embodiment 4. It should be noted that the centrifugal air-sending device 100 is used as an indoor air-sending device 158 of the refrigeration cycle apparatus 150 according to Embodiment 4. Further, although the following description describes a case in which the refrigeration cycle apparatus 150 is used for an air-conditioning purpose, the refrigeration cycle apparatus 150 is not limited to being used for an air-conditioning purpose. The refrigeration cycle apparatus 150 is used for a refrigeration purpose or an air-conditioning purpose served in a device such as a refrigerator, a freezer, a vending machine, an air-conditioning apparatus, a refrigeration apparatus, and a water heater.

The refrigeration cycle apparatus 150 according to Embodiment 4 performs air conditioning by heating or cooling the interior of a room by transferring heat between outside air and indoor air via refrigerant. The refrigeration cycle apparatus 150 according to Embodiment 4 includes an outdoor unit 200 and an indoor unit 300. The refrigeration cycle apparatus 150 is configured such that the outdoor unit 200 and the indoor unit 300 are connected by a refrigerant pipe 160 and a refrigerant pipe 170 thus forming a refrigerant circuit through which refrigerant circulates.

The refrigerant pipe 160 is a gas pipe through which gas-phase refrigerant flows, and the refrigerant pipe 170 is a liquid pipe through which liquid-phase refrigerant flows. It should be noted that two-phase gas-liquid refrigerant may flow through the refrigerant pipe 170. Moreover, in the refrigerant circuit of the refrigeration cycle apparatus 150, a compressor 151, a flow switching device 152, an outdoor heat exchanger 153, an expansion valve 154, and an indoor heat exchanger 155 are connected in sequence via refrigerant pipes.

### (Outdoor Unit 200)

The outdoor unit 200 includes the compressor 151, the flow switching device 152, the outdoor heat exchanger 153, and the expansion valve 154. The compressor 151 sucks refrigerant, compresses the refrigerant thus sucked, and discharges the refrigerant thus compressed. The flow switching device 152 is a device, such as a four-way valve, configured to switch directions of refrigerant flow passages. The refrigeration cycle apparatus 150 achieves a heating operation or a cooling operation by using the flow switching device 152 to switch the flows of refrigerant in accordance with an instruction from a controller (not illustrated).

The outdoor heat exchanger 153 exchanges heat between the refrigerant and outdoor air. The outdoor heat exchanger 153 acts as an evaporator during the heating operation to, by exchanging heat between low-pressure refrigerant flowing in from the refrigerant pipe 170 and outdoor air, evaporate and gasify the refrigerant. The outdoor heat exchanger 153 acts as a condenser during the cooling operation to, by exchanging heat between refrigerant flowing in from the flow switching device 152 after being compressed by the compressor 151 and outdoor air, to condense and liquefy the refrigerant.

The outdoor heat exchanger 153 is provided with an outdoor air-sending device 157 to increase the efficiency of heat exchange between the refrigerant and outdoor air. The outdoor air-sending device 157 may have an inverter device attached to the outdoor air-sending device 157 to change the rotation speed of a fan by changing the operating frequency of a fan motor. The expansion valve 154 is an expansion device (flow rate control means) and, by adjusting the flow rate of refrigerant that flows through the expansion valve 154, operates as an expansion valve to adjust the pressure of the refrigerant by changing an opening degree. For example, in a case in which the expansion valve 154 is an electronic expansion valve or other valve, the opening degree is adjusted in accordance with an instruction from the controller (not illustrated).

### (Indoor Unit 300)

The indoor unit 300 includes the indoor heat exchanger 155, which exchanges heat between the refrigerant and indoor air, and the indoor air-sending device 158, which adjusts the flow of air with which the indoor heat exchanger 155 exchanges heat. The indoor heat exchanger 155 acts as a condenser during the heating operation to exchange heat between refrigerant flowing in from the refrigerant pipe 160 and indoor air, condense and liquefy the refrigerant, and cause the refrigerant to flow out toward the refrigerant pipe 170. The indoor heat exchanger 155 acts as an evaporator during the cooling operation to exchange heat between refrigerant brought into a low-pressure state by the expansion valve 154 and indoor air, evaporate and gasify the refrigerant by causing the refrigerant to take heat away from the air, and cause the refrigerant to flow out toward the refrigerant pipe 160. The indoor air-sending device 158 is provided to face the indoor heat exchanger 155.

As the indoor air-sending device 158, the centrifugal air-sending device 100 according to Embodiment 1 or the centrifugal air-sending device 100 according to Embodiment 2 is applied. The operating speed of the indoor air-sending device 158 is determined by a user's setting. The indoor air-sending device 158 may have an inverter device attached to the indoor air-sending device 158 to change the rotation speed of the impeller 10 (see FIG. 1) by changing the operating frequency of a fan motor (not illustrated).

### [Example of Operation of Refrigeration Cycle Apparatus 150]

Next, the cooling operation is described as an example of operation of the refrigeration cycle apparatus 150. High-temperature and high-pressure gas refrigerant compressed and discharged by the compressor 151 flows into the outdoor heat exchanger 153 via the flow switching device 152. The gas refrigerant flowing into the outdoor heat exchanger 153 condenses into low-temperature refrigerant by exchanging heat with outside air sent by the outdoor air-sending device 157 and flows out from the outdoor heat exchanger 153.

The refrigerant flowing out from the outdoor heat exchanger 153 is expanded and decompressed by the expansion valve 154 into low-temperature and low-pressure two-phase gas-liquid refrigerant. This two-phase gas-liquid refrigerant flows into the indoor heat exchanger 155 of the indoor unit 300, evaporates by exchanging heat with indoor air sent by the indoor air-sending device 158, and turns into low-temperature and low-pressure gas refrigerant that then flows out from the indoor heat exchanger 155. At this point in time, the indoor air cooled by having its heat removed by the refrigerant tums into air-conditioning air that is then blown out to the air-conditioned space through a discharge port of the indoor unit 300. The gas refrigerant flowing out from the indoor heat exchanger 155 is sucked into the compressor 151 via the flow switching device 152 and is compressed again. The foregoing operation is repeated.

Next, the heating operation is described as an example of operation of the refrigeration cycle apparatus 150. High-temperature and high-pressure gas refrigerant compressed and discharged by the compressor 151 flows into the indoor heat exchanger 155 of the indoor unit 300 via the flow switching device 152. The gas refrigerant flowing into the indoor heat exchanger 155 condenses into low-temperature refrigerant by exchanging heat with indoor air sent by the indoor air-sending device 158 and flows out from the indoor heat exchanger 155. At this point in time, the indoor air heated by receiving heat from the gas refrigerant turns into air-conditioning air that is then blown out to the air-conditioned space through the discharge port of the indoor unit 300.

The refrigerant flowing out from the indoor heat exchanger 155 is expanded and decompressed by the expansion valve 154 into low-temperature and low-pressure two-phase gas-liquid refrigerant. This two-phase gas-liquid refrigerant flows into the outdoor heat exchanger 153 of the outdoor unit 200, evaporates by exchanging heat with outside air sent by the outdoor air-sending device 157, and turns into low-temperature and low-pressure gas refrigerant that then flows out from the outdoor heat exchanger 153. The gas refrigerant flowing out from the outdoor heat exchanger 153 is sucked into the compressor 151 via the flow switching device 152 and is compressed again. The foregoing operation is repeated.

The refrigeration cycle apparatus 150 according to Embodiment 4 includes the centrifugal air-sending device 100 according to Embodiment 1 or 2. Therefore, the refrigeration cycle apparatus 150 brings about effects similar to those of the centrifugal air-sending device 100 according to Embodiment 1 or 2.

Embodiments 1 to 4 may be implemented in combination with each other. Further, the configurations shown in the foregoing embodiments show examples and may be combined with another publicly-known technology, and parts of the configurations may be omitted or changed, provided such omissions and changes do not depart from the scope.

### REFERENCE SIGNS LIST

9a: motor support, 10: impeller, 10L: impeller, 10a: outer circumferential side surface, 10e: air inlet, 11: main plate, 11b: boss portion, 11b1: shaft hole, 12: blade, 12A: first blade, 12A1: first outer circumferential vane portion, 12A11: first outer circumferential region, 12A2: first inner circumferential vane portion, 12A21: first inner circumferential region, 12B: second blade, 12B1: second outer circumferential vane portion, 12B11: second outer circumferential region, 12B2: second inner circumferential vane portion, 12B21: second inner circumferential region, 13: side plate, 13a: first side plate, 13b: second side plate, 14A: inner circumferential end, 14A1: leading edge, 14B: inner circumferential end, 14B1: leading edge, 14C: inner circumferential end, 15: heat exchanger, 15A: outer circumferential end, 15A1: trailing edge, 15B: outer circumferential end, 15B1: trailing edge, 15C: outer circumferential end, 16: case, 16a: upper surface portion, 16b: lower surface portion, 16c: side surface portion, 17: case discharge port, 18: case suction port, 19: divider, 22: inner blade portion, 23: first vane portion, 23a: outer first vane portion, 24: second vane portion, 24a : outer second vane portion, 26: outer circumferential blade portion, 40: scroll casing, 41: scroll portion, 41a: scroll start portion, 41b: scroll end portion, 42: discharge portion, 42a: discharge port, 42b: extension plate, 42c: diffuser plate, 42d: first side plate portion, 42e: second side plate portion, 43: tongue portion, 44a : side wall, 44a1: first side wall, 44a2: second side wall, 44c: circumferential wall, 45: case air inlet, 45a: first air inlet, 45b: second air inlet, 46: bell mouth, 46a: inner circumferential edge portion, 46b: inner circumferential end portion, 50: motor, 51: motor shaft, 71: first plane, 72: second plane, 100: centrifugal air-sending device, 100L: centrifugal air-sending device, 112a: first air-sending portion, 112b: second air-sending portion, 122a: main-plate-side blade region, 122b: side-plate-side blade region, 140: air-conditioning apparatus, 141A: inclined portion, 141B: inclined portion, 150: refrigeration cycle apparatus, 151: compressor, 152: flow switching device, 153: outdoor heat exchanger, 154: expansion valve, 155: indoor heat exchanger, 157: outdoor air-sending device, 158: indoor air-sending device, 160: refrigerant pipe, 170: refrigerant pipe, 200: outdoor unit, 231: outer circumferential first arc portion, 232: outer circumferential first arc portion, 233: outer circumferential first arc portion, 234a: outer circumferential first arc portion, 234b: outer circumferential second arc portion, 235a: outer circumferential first arc portion, 235b: outer circumferential second arc portion, 236a: outer circumferential first arc portion, 236b: outer circumferential second arc portion, 242: inner circumferential first arc portion, 243a: inner circumferential first arc portion, 243b: inner circumferential second arc portion, 244: inner circumferential first arc portion, 245a: inner circumferential first arc portion, 245b: inner circumferential second arc portion, 246: inner circumferential first arc portion, 300: indoor unit, AR: current of air, BI: inside diameter, BO: outside diameter, C1: circle, C1a: circle, C2: circle, C2a: circle, C3: circle, C3a: circle, C4: circle, C7: circle, C7a: circle, C8: circle, CD: circumferential direction, CL1: center line, CL2: center line, CL3: center line, CL4: center line, CL5: center line, CL6: center line, ID1: inside diameter, ID1a: inside diameter, ID2: inside diameter, ID2a: inside diameter, ID3: inside diameter, ID3a: inside diameter, ID4: inside diameter, ID4a : inside diameter, L: arrow outline, L1a: vane length, L1b: vane length, L2a: vane length, L2b: vane length, MP: middle point, MS: distance, OD: blade outside diameter, OD1: outside diameter, OD2: outside diameter, OD3: outside diameter, OD4: outside diameter, R: direction of rotation, RA: rotation axis, S11: space, S12: space, SL: distance, TL1: tangent line, TL2: tangent line, TL3: tangent line, TL4: tangent line, TL5: tangent line, TL6: tangent line, W: width dimension, WS: range, α1: outlet angle, α2: outlet angle, β1: outlet angle, β2: outlet angle, γ1: inlet angle, γ2: inlet angle

1. A centrifugal air-sending device comprising:
an impeller that includes a main plate to be driven to rotate, a side plate that is annularly shaped and faces the main plate, and a plurality of blades that are connected to the main plate at one end of each of the plurality of blades, connected to the side plate at an other end of each of the plurality of blades, and arranged in a circumferential direction centered around a rotation axis of the main plate that is virtually drawn; and
a scroll casing that houses the impeller and includes a circumferential wall formed in a spiral shape and a side wall that includes a bell mouth that defines an air inlet that communicates with a space defined by the main plate and the plurality of blades,
each of the plurality of blades being formed such that a vane length of the blade decreases from a portion of the blade close to the main plate toward a portion of the blade close to the side plate,
each of the plurality of blades including
an inner circumferential end located closer to the rotation axis than is an outer circumferential end in a radial direction that starts from the rotation axis as a radial center,
the outer circumferential end located closer to an outer circumference of the blade than is the inner circumferential end in the radial direction,
a first vane portion that forms a blade that includes the outer circumferential end and is formed such that an outlet angle is formed at 90 degrees or less and the first vane portion is connected to the side plate, and
a second vane portion that includes the inner circumferential end, a turbo vane that forms a backward-curved blade, and a portion close to the main plate in an axial direction of the rotation axis that protrudes further inward than the bell mouth when the second vane portion is viewed in the axial direction of the rotation axis,
the plurality of blades being formed such that a blade outer diameter defined by the outer circumferential ends of the plurality of blades is larger than an inner diameter of the bell mouth,
part of the second vane portion being bent and thus including at least one arc-shaped portion when the part of the second vane portion is viewed in the axial direction of the rotation axis,
the part of the second vane portion being formed and curving out in a direction opposite to a direction of rotation of the plurality of blades and being formed open in the direction of rotation when the part of the second vane portion is viewed in the axial direction of the rotation axis

2. The centrifugal air-sending device of claim 1, wherein
the first vane portion and the second vane portion are each bent and thus include at least one arc-shaped portion when the first vane portion and the second vane portion are viewed in the axial direction of the rotation axis, and
the first vane portion and the second vane portion are formed such that a radius of curvature of the first vane portion is smaller than a radius of curvature of the second vane portion.

3. (canceled)

4. The centrifugal air-sending device of claim 1, wherein
part of the first vane portion is bent and thus includes at least one arc-shaped portion when the part of the first vane portion is viewed in the axial direction of the rotation axis, and
the at least one arc-shaped portion of the first vane portion is formed integrally with the side plate by being connected to an inner circumferential end of the side plate.

5. (canceled)

6. The centrifugal air-sending device of claim 1, wherein
each of the plurality of blades includes an outer circumferential blade portion that forms a portion located closer to the outer circumference than is an inner circumferential end portion that is an end portion of an inner circumference of the bell mouth in the radial direction, and
the outer circumferential blade portion is formed such that a ratio of the second vane portion in the radial direction is larger than a ratio of the first vane portion in the radial direction.

7. The centrifugal air-sending device of claim 1, wherein
each of the plurality of blades includes an outer circumferential blade portion that forms a portion located closer to the outer circumference than is an inner circumferential end portion that is an end portion of an inner circumference of the bell mouth in the radial direction, and
the outer circumferential blade portion is formed such that a ratio of the second vane portion in the radial direction is smaller than a ratio of the first vane portion in the radial direction.

8. The centrifugal air-sending device of claim 1, wherein each of the plurality of blades has a portion between the main plate and the side plate in which the vane length is constant in size.

9. The centrifugal air-sending device of claim 1, wherein each of the plurality of blades is shaped such that the vane length continuously changes in size from the main plate to the side plate.

10. An air-conditioning apparatus comprising the centrifugal air-sending device of claim 1.

11. A refrigeration cycle apparatus comprising the centrifugal air-sending device of claim 1.
